(19) United States
(12) Patent Application Publication
(10) Pub. No.: US 2025/0340313 A1
(43) Pub. Date: Nov. 6, 2025

(54) AUTONOMOUS UNMANNED AERIAL VEHICLE WITH INTEGRATED LASER - BASED TARGETING AND OBJECT DETECTION SYSTEM

(71) Applicant: Nick REYNTJENS, Bankso (BG)

(72) Inventor: Nick REYNTJENS, Bankso (BG)

(21) Appl. No.: 18/952,368

(22) Filed: Nov. 19, 2024

Related U.S. Application Data
(60) Provisional application No. 63/619,605, filed on Jan. 10, 2024.
(60) Provisional application No. 63/642,905, filed on May 6, 2024.

(30) Foreign Application Priority Data
Nov. 19, 2023 (PT) 20232005591675
May 28, 2024 (PT) 20242006160748
Jun. 17, 2024 (GB) 2408624.1
Aug. 25, 2024 (PT) 20242006416607

(51) Int. Cl. B64U 10/14; B64U 20/87; B64U 101/30

(52) U.S. Cl. CPC B64U 10/14; B64U 20/87; B64U 2101/30; B64U 2201/10

(57) ABSTRACT

The application relates to an autonomous unmanned aerial vehicle (UAV) with a laser-based targeting and object detection system. The UAV may feature a main body with thrust-producing means, a camera, a laser unit, and an optical unit integrating movable mirrors and dichroic optics to align the laser and camera paths. A control unit may analyze camera images to detect objects and adjust the laser beam for precise targeting.

The UAV may be ideal for precision pest control, military operations, and environmental management, such as weed removal. Advanced algorithms may enable accurate detection and engagement, while dynamic focusing mechanisms and integrated cooling systems may ensure reliable operation. Safety protocols prevent unintended exposure.

The UAV may support battery-swapping for extended use and can function within drone swarms for optimized efficiency. Stored operational data may enhance future planning, providing a robust solution for automated, targeted environmental interaction.

### CROSS REFERENCE TO RELATED APPLICATIONS

This application claims the benefit of Portuguese Provisional Application No. 20232005591675, titled “Autonomously moving apparatus for killing agricultural insect pests”, filed by Nick Alex L. Reyntjens, on Nov. 19, 2023.

This application claims the benefit of U.S. Provisional Application No. 63/619,605, titled “Autonomously moving apparatus for killing agricultural insect pests”, filed by Nick Alex L. Reyntjens, on Jan. 10, 2024.

This application claims the benefit of U.S. Provisional Application No. 63/642,905, titled “Autonomously moving apparatus for killing agricultural insect pests by laser”, filed by Nick Alex L. Reyntjens, on May 6, 2024.

This application claims the benefit of Portuguese Provisional Application No. 20242006160748, titled “Autonomously moving apparatus for killing agricultural insect pests”, filed by Nick Alex L. Reyntjens, on May 28, 2024.

This application claims the benefit of Portuguese Provisional Application No. 20/242,006416607, titled “AUTONOMOUS APPARATUS FOR MAINLY LASER-BASED NEUTRALIZATION OF AGRICULTURAL PESTS”, filed by Nick Alex L. Reyntjens, on Aug. 25, 2024.

This application claims the benefit of UK Patent Application No. 2408624.1, titled “AUTONOMOUS APPARATUS FOR MAINLY LASER-BASED NEUTRALIZATION OF AGRICULTURAL PESTS”, filed by Nick Alex L. Reyntjens, on Jun. 17, 2024.

This application incorporates the entire contents of each of the foregoing application(s) herein by reference.

### TECHNICAL FIELD

Various embodiments relate generally to autonomous unmanned aerial vehicles with laser-based precision targeting systems.

### BACKGROUND

In recent years, unmanned aerial vehicles (UAVs), commonly referred to as drones, have gained significant attention across various industries due to their versatility and wide range of applications. From precision agriculture and infrastructure monitoring to military operations and environmental conservation, UAVs are increasingly used for tasks requiring high mobility, accuracy, and automation.

One of the critical challenges in many UAV applications is the ability to interact with the environment in a targeted and precise manner. For example, in agricultural pest control, UAVs can be equipped with sprayers to distribute pesticides over a large area, but such methods lack the precision to target specific pests, leading to unnecessary chemical use and environmental harm. Similarly, in military or security applications, the precise identification and engagement of targets remain complex tasks requiring advanced targeting systems. Enhanced precision in military applications not only improves mission effectiveness but also minimizes collateral damage and saves ammunition.

The integration of laser-based systems into UAVs opens new possibilities for targeted interaction with the environment. Unlike sensing laser systems such as LiDAR, these non-sensing laser-based systems are designed to deliver highly focused energy to specific points, making them ideal for applications such as precision pest control, weed management, or military operations. However, such systems require advanced optical and control mechanisms to ensure the laser beam is accurately aligned with the detected objects in the environment.

Existing UAV systems with laser functionality often face limitations in terms of precision, versatility, and adaptability. Aligning a laser beam with the camera's optical path, ensuring precise targeting, and compensating for UAV movement are technically challenging aspects that need to be addressed. Additionally, the dynamic control of laser focus and beam direction is critical for effectively engaging with objects at varying distances and angles.

The present application addresses these challenges by providing an autonomously operating UAV equipped with an advanced optical unit, a laser system, and a control unit. This system preferably leverages a movable mirror, dichroic mirror, and sophisticated image analysis algorithms to enable precise detection, localization, and targeting of objects in the UAV's environment. The proposed solution here is adaptable for a variety of applications, including agricultural pest control, weed management, and military or security operations, offering a highly efficient and versatile solution for targeted environmental interaction.

### SUMMARY

In a first aspect, the application relates to an autonomously operating unmanned aerial vehicle which comprises a main body with at least one thrust producing means, a camera, a laser unit, an optical unit, and a control unit. The camera is preferably configured to capture images of an environment, and the laser unit is preferably configured to emit at least one laser beam. Further, the optical unit is preferably operatively coupled to both the laser unit and the camera and comprises at least one movable mirror and preferably a dichroic mirror. In this respect, the dichroic mirror is preferably configured to reflect the laser beam and to be transparent to an optical path of the camera, or vice versa, so that the optical path of the camera is aligned with a path of the laser beam and both the optical path of the laser beam and the optical path of the camera are directed at the movable mirror. The control unit may comprise a processor, a memory and one or more communication units which are preferably in data communication with the laser unit, the camera and the optical unit. The control unit may be configured to analyze the camera images to detect objects and determine their location parameters, which can be used to direct the laser beam onto targeted objects using the moveable mirror.

The term “autonomously operating” refers preferably to the capability of a the unmanned aerial vehicle to perform its intended functions, including flight, without direct human intervention during operation. This means that the unmanned aerial vehicle independently utilizes its integrated components, such as the control unit, camera, laser unit, optical unit, and additional sensors like a global positioning system (GPS), to execute tasks such as maintaining stable flight, navigating through its environment, detecting objects, determining position parameters, and precisely directing the laser beam. The control unit, which may include a processor and memory, analyzes the images captured by the camera, identifies objects, calculates their locations, and adjusts the movable mirror to accurately target objects with the laser beam. At the same time, the global positioning system and other sensors enable autonomous navigation and ensure flight stability. By combining automated flight capabilities with real-time data analysis and adaptive decision-making, the unmanned aerial vehicle operates as a fully independent and intelligent system.

In a further aspect, the application relates to an autonomously operating unmanned aerial vehicle which may comprise a main body with at least one thrust producing means, a camera, a laser unit, an optical unit, and a control unit. The camera is preferably configured to capture images of an environment, and the laser unit is preferably configured to emit at least one laser beam. Additionally, the optical unit is preferably operatively coupled to both the laser unit and the camera and comprises at least a dichroic mirror, wherein the dichroic mirror is preferably configured to reflect the laser beam and to be transparent to an optical path of the camera, or vice versa. The laser unit may comprise an actuator for directing the laser beam to the dichroic mirror, or alternatively the optical unit may comprise a movable mirror at which the laser beam can be aimed for directing the laser beam to the dichroic mirror. The control unit may comprise a processor, a memory and one or more communication units which are in data communication with the laser unit and the camera, wherein the control unit is preferably configured to analyze the camera images to detect objects and determine their location parameters, which can be used to direct the laser beam onto targeted objects using the laser unit's actuator or the movable mirror.

In a further aspect, the application relates to an autonomously operating unmanned aerial vehicle which may comprise a main body with at least one thrust producing means, a camera, a laser unit, and a control unit. The camera is preferably configured to capture images of an environment, and the laser unit is preferably configured to emit at least one laser beam. Moreover, the control unit may comprise a processor, a memory and one or more communication units which are in data communication with the laser unit and the camera, wherein the control unit is preferably configured to analyze the camera images to detect objects and determine their location parameters, which can be used to direct the laser beam onto targeted objects.

The aerial vehicle according to any of the preceding aspects may be configured in various embodiments. Different embodiments can achieve one or more advantages. For example, certain embodiments may include means for converging a laser beam or focusing multiple laser beams to a point at a specific distance. This can lead to enhanced safety by minimizing unintended beam dispersion, reducing the risk of collateral damage or interference in sensitive environments. Furthermore, the precise control over the laser's focal point ensures that energy is only delivered where intended, preventing accidental exposure and improving operational reliability in complex or crowded settings. Further advantageous embodiments are detailed in the description of the present application, each of which may be combined with any of the previously mentioned aspects of the aerial vehicle.

Furthermore, the aerial vehicle according to any of the preceding aspects may be suitable for targeted pest control in an agricultural environment. The camera may be configured to capture environmental images of the agricultural environment, and the control unit may be configured to analyze the camera images to detect pests and determine their location parameters, which can be used to direct the laser beam onto targeted pests, for example, by using the moveable mirror or a laser unit's actuator.

The aerial vehicle according to any of the preceding aspects may be suitable for military applications. In this respect, the camera may be configured to capture images of the environment, and the control unit may be configured to analyze the camera images to detect military targets, such as human eyes, and determine their location parameters, which can be used to direct the laser beam onto the military targets, for example, by using the moveable mirror or a laser unit's actuator.

Moreover, the aerial vehicle according to any of the preceding aspects may be suitable for burning weeds or leaves. The camera can be configured to capture images of the environment, and the control unit can be configured to analyze the camera images to detect unwanted vegetation and determine their location parameters, which can be used to direct the laser beam onto the weeds or leaves, for example, by using the moveable mirror or a laser unit's actuator.

In a further aspect, the application relates to a system comprising the aerial vehicle according to any of the preceding aspects, a designated landing area and a mechanism for separating a replaceable battery from the aerial vehicle. The mechanism is preferably capable of autonomously reaching the majority of locations within the designated landing area and is not fixed to the length of the designated landing area. The mechanism may be not fixed with rigid linkages (such as a fixed robotic arm) or constrained by rails. Instead, it is configured to move freely across the platform within the designated landing area. The mechanism is preferably configured to autonomously approach the aerial vehicle after it has landed on the designated landing area, and to separate the battery from the aerial vehicle as part of a battery swap operation.

Further examples of embodiments are explained in more detail below with reference to the accompanying drawings. The invention is not intended to be limited solely to these listed examples of embodiments. They merely serve to explain the invention in more detail. The present invention is intended to relate to all objects which the person skilled in the art would use now and, in the future, as obvious to realize the invention.

### BRIEF DESCRIPTION OF DRAWINGS

FIG. 1 shows a preferred embodiment of the aerial vehicle.

FIG. 2 shows a schematic view of the interaction between the laser unit, the camera and the optical unit in a preferred embodiment of the aerial vehicle.

FIG. 3 shows essentially the schematic illustration presented in FIG. 2 in greater detail, depicted here as a 3D model in a sectional view.

FIG. 4 shows a schematic illustration of the interaction between the laser unit and the optical unit in a further preferred embodiment of the aerial vehicle.

FIG. 5 shows a schematic illustration of the interaction between the laser unit and the optical unit in a further preferred embodiment of the aerial vehicle.

FIG. 6 shows a more detailed representation of the schematic illustration presented in FIG. 5, depicted here as a 3D model in a sectional view.

FIG. 7 shows a schematic illustration of the interaction between the laser unit, the camera and the optical unit in a further preferred embodiment of the aerial vehicle.

FIG. 8 shows a schematic illustration of the interaction between the laser unit, the camera and the optical unit in a further preferred embodiment of the aerial vehicle.

FIG. 9 shows a schematic illustration of a laser beam exiting an optical unit equipped with a means for converging the laser beam.

FIG. 10 shows a schematic illustration of the interaction between the laser unit, the camera and the optical unit in a further preferred embodiment of the aerial vehicle.

FIG. 10A shows a preferred embodiment of a movable mirror.

FIG. 11 shows a further preferred embodiment of the aerial vehicle.

FIG. 12 shows the roll motion of the housing via gimbal, showcasing its rotational degree of freedom around the roll axis.

FIG. 13 shows the pitch motion of the housing via gimbal, demonstrating its rotational capability around the pitch axis.

FIG. 14 shows the yaw motion of the housing via gimbal, highlighting its rotational flexibility around the yaw axis.

FIG. 15 shows a detailed view of the housing of the embodiment illustrated in FIGS. 11-14.

FIG. 15A shows a cross section of the housing illustrated in FIG. 15.

FIG. 16 shows both an exploded view and an assembled view of a cooling component in a preferred embodiment of the cooling unit.

FIG. 17 shows a further preferred embodiment of the aerial vehicle.

FIG. 18 shows a further preferred embodiment of the aerial vehicle.

FIG. 19 shows a side view of the preferred embodiment of the aerial vehicle depicted in FIG. 18.

FIG. 19A shows a preferred embodiment of the aerial vehicle illustrated in FIG. 18 and FIG. 19, depicted in an operating state where the laser beam is emitted from the aerial vehicle.

FIG. 20 shows a further preferred embodiment of the aerial vehicle, which may be designed as a high-speed drone.

FIG. 21 shows a preferred embodiment of the battery used in the aerial vehicle.

FIG. 22 shows a preferred embodiment of a mechanism for separating the replaceable battery from the aerial vehicle.

FIG. 23 shows a further preferred embodiment of the aerial vehicle.

FIG. 24 shows a further preferred embodiment of the arrangement between control unit, the laser unit, optical and the camera.

FIG. 24A shows a preferred embodiment of a movable mirror coupled to two servo motors, allowing it to be adjusted in two dimensions, making it fit the definition of a fast steering mirror, since the movable mirror can be moved in two rotational angles.

FIG. 24B shows the embodiment of the movable mirror of FIG. 24A from a different perspective.

FIG. 25 shows a particularly compact embodiment of the arrangement involving the laser unit, the optical unit, and the camera.

FIG. 26 shows a preferred embodiment shown in FIG. 25 in an exploded view, allowing the individual components to be seen in greater detail.

### DETAILED DESCRIPTION OF ILLUSTRATIVE EMBODIMENTS

Some parts of the embodiments have similar or identical parts. The similar or identical parts may have the same names and/or reference number. The description of one part applies by reference to another similar part, where appropriate, thereby reducing repetition of text without limiting the disclosure.

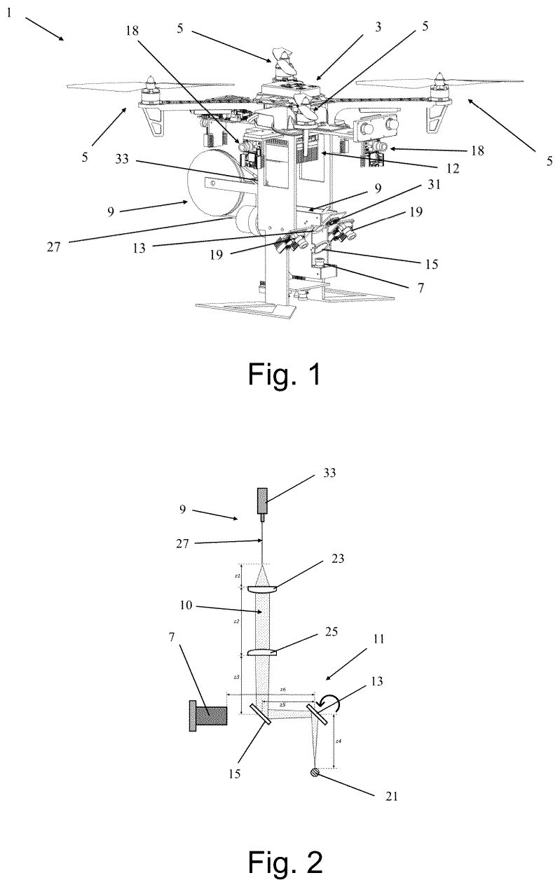

FIG. 1 shows a preferred embodiment of an aerial vehicle 1. The aerial vehicle 1 may be autonomously operating, unmanned, and may comprise a main body 3 with at least one thrust-producing means 5, preferably four thrust-producing means 5, a camera 7, a laser unit 9, an optical unit 11, and a control unit 12.

The camera 7 may be configured to capture images of the environment, while the laser unit 9 may be configured to emit at least one laser beam 10. The optical unit 11, which may be operatively coupled to both the laser unit 9 and the camera 7, can comprise at least one movable mirror 13 and a dichroic mirror 15. The dichroic mirror 15 may be designed to reflect the laser beam 10 and to be transparent to the optical path of the camera 7, or vice versa. This configuration can allow the optical path of the camera 7 to align with the path of the laser beam 10, so that both the laser beam's optical path and the camera's optical path are directed toward the movable mirror 13.

The control unit 12 may comprise a processor, a memory, and one or more communication units, which can be in data communication with the laser unit 9, the camera 7, and the optical unit 11. The control unit 12 can be configured to analyze the images captured by the camera 7 to detect objects and determine their location parameters. These parameters may be used to direct the laser beam 10 onto targeted objects via the movable mirror 13.

In a preferred embodiment, the one or more communication units may be wired or wirelessly coupled to the laser unit 9, the camera 7, and the optical unit 11. Additionally, the one or more communication units may enable data exchange between the aerial vehicle 1 and external systems, such as a ground control station or other aerial vehicles 1. This data exchange may include transmitting images captured by the camera 7, location parameters of detected objects, or operational status information of the aerial vehicle 1. Furthermore, the communication units may receive commands or mission updates from external systems, allowing the aerial vehicle 1 to dynamically adapt its operation.

In this context, a preferred embodiment of the application may address a drone swarm comprising a plurality of aerial vehicles 1, wherein each aerial vehicle 1 is in data communication with the others and can communicate with one another.

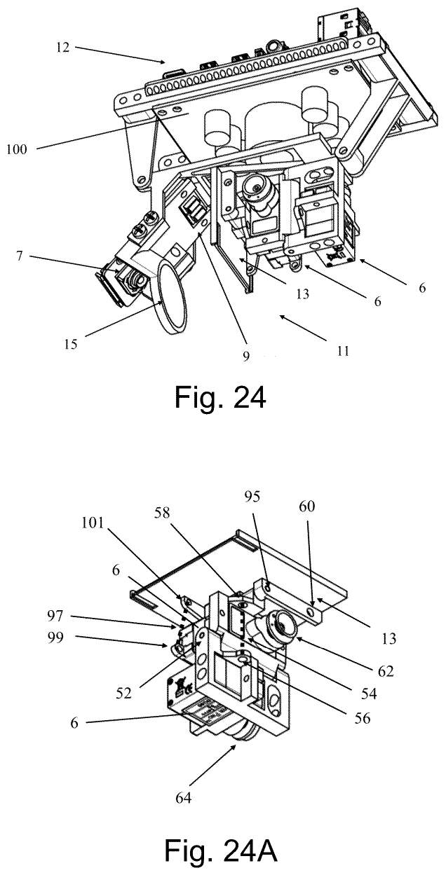

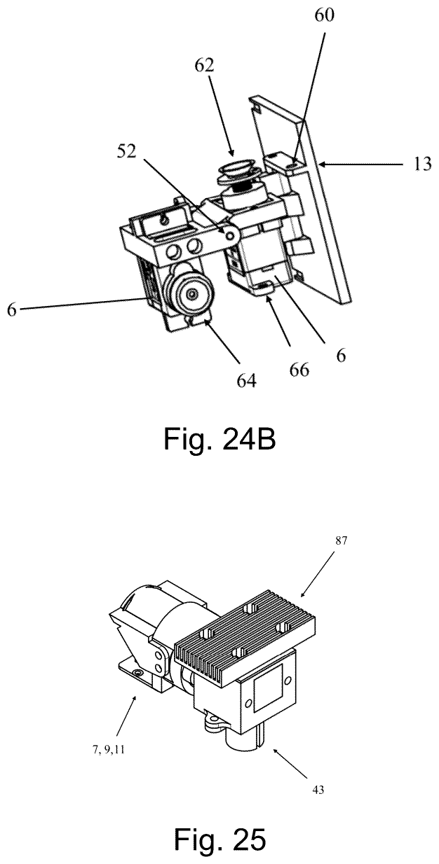

Preferably, the laser unit 9 comprises a fiber 27 coupled laser light source 33 and a collimating lens 23. In alternative embodiments, the laser unit 9 may include differently configured laser designs, particularly those that do not utilize a fiber (see, for example, FIG. 24).

The laser unit 9 may comprise a laser light source 33 having a dominant wavelength of between 449 nm and 461 nm or of between 798 nm and 818 nm. In particularly preferred embodiments, the laser source 33 operates within the range of 449 nm to 461 nm, as blue wavelengths are highly absorbed by insects and plants, which minimizes unwanted reflections and maximizes the efficiency of energy transfer to the target. This reduces the risk of accidental harm to humans or animals by limiting the likelihood of the laser beam 10 bouncing off surfaces. Additionally, blue light is particularly suitable for agricultural applications due to its ability to avoid strong reflection from most plant and soil surfaces, thereby ensuring precise targeting of pests. The specified range of 798 nm to 818 nm, on the other hand, is optimized for generating thermal effects, where the near-infrared laser delivers concentrated heat to neutralize pests effectively.

In some preferred embodiments, the laser unit may comprise a light source 33 with a power of 5.5 W. The light source 33 may be either a pulsed light source 33 or a continuous one. Pulsed operation is particularly advantageous for precise energy delivery and minimizing thermal damage to surrounding areas, while continuous operation allows for consistent energy output, ideal for neutralizing larger pest populations or for use in applications requiring sustained targeting. In some embodiments, the power of the light source 33 may range from 2 W to 100 W, preferably from 3 W to 60 W, and more particularly from 4 W to 10 W.

The laser unit 9 may comprise a laser driver circuit utilizing at least one transistor selected from the group consisting of a Silicon Carbide (SiC) MOSFET and a Gallium Nitride (GaN) FET. These transistors are particularly well-suited for high-frequency and high-power applications, making them ideal for driving the laser source 33 with precision and efficiency. SiC MOSFETs are known for their high thermal conductivity and ability to operate at elevated temperatures, which ensures reliable performance even under demanding conditions. GaN FETs, on the other hand, offer extremely low switching losses and fast response times.

The four thrust-producing means 5 may each comprise at least one propeller, which can generate unidirectional thrust to allow the unmanned aerial vehicle 1 to achieve and preferably maintain controlled movement. By adjusting the speed and direction of rotation of these propellers, the vehicle 1 may perform various maneuvers, such as ascending, descending, hovering, or moving laterally, forward, or backward.

By distributing the rotational speed and thus the thrust output of each propeller using a ‘mixing’ matrix, pitch, roll, and yaw rotational forces can be introduced while maintaining a given total thrust. For instance, increasing the rotational speed on one side while reducing it on the opposite side may allow the vehicle to tilt, enabling directional movement in the desired direction. Similarly, varying the the rotational speed diagonally may induce rotation around the vehicle's vertical axis, allowing it to turn or reorient as needed.

To enable smooth and accurate movement, the system may rely on additional sensors, such as accelerometers, gyroscopes, and global positioning systems, which can provide continuous data about the vehicle's position, orientation, and velocity. This data can be processed by the control unit 12, which may dynamically adjust the thrust produced by the propellers in real time to preferably maintain stability and execute the desired motion. By combining this control with 12 advanced navigation algorithms, the unmanned aerial vehicle 1 may autonomously follow pre-programmed flight paths, avoid obstacles, and react to changes in its environment.

In further examples, the aerial vehicle 1 may comprise at least one propeller which can be dynamically rearrangeable and configured to provide mainly vertical thrust or horizontal thrust. In an alternative embodiment, the thrust producing means 5 may comprise at least two propellers, wherein a first propeller is configured to provide mainly vertical thrust and a second propeller is configured to provide mainly horizontal thrust.

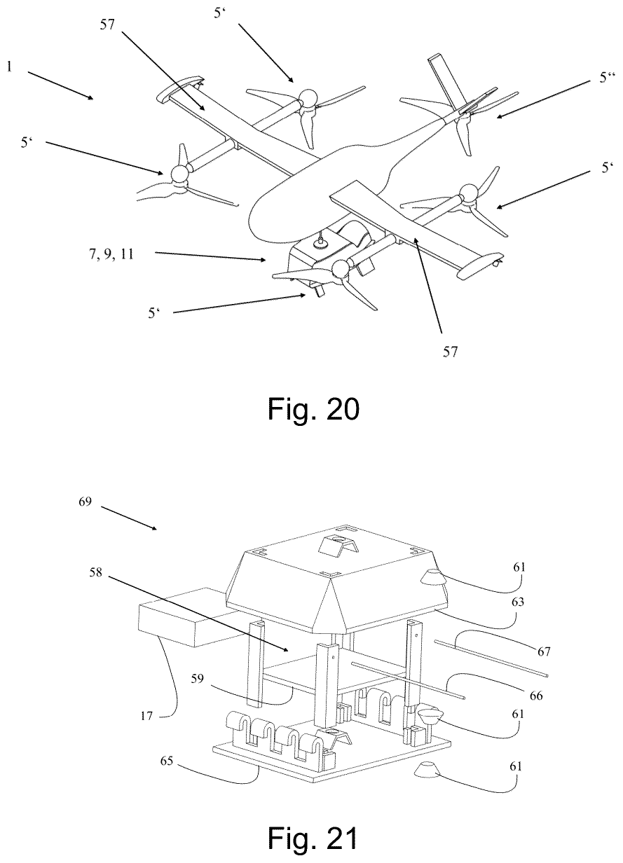

Furthermore, the aerial vehicle 1 may further comprise at least one wing 57 that generates lift when the aerial vehicle 1 moves forward (see, for example, FIG. 20).

The aerial vehicle 1 may further comprise a replaceable battery 17 (see, for example, FIG. 21), wherein all power consuming components on the vehicle 1 are coupled to the battery 17 as a power source. The replaceable battery 17 may be suitable for automatic swapping.

Preferably, the aerial vehicle 1 may further comprise a stereo camera 19. Generally, an aerial vehicle 1 may also comprise an event camera, or an infrared camera in data communication with the control unit 12 to further analyze the environment. These cameras may, for example, be arranged as sideward-facing cameras 18.

Further preferred, at least one LED 31 may be provided on the vehicle 1 to illuminate the field of view of the camera 7, thereby enhancing the quality of captured images, particularly in low-light conditions. The LED 31 can be controlled by the control unit 12 and may be activated dynamically based on environmental lighting conditions or specific operational requirements.

The aerial vehicle 1 may be suitable for different applications. For example, it may be used for targeted pest control in an agricultural environment, wherein the camera 7 is configured to capture images of the agricultural environment, and the control unit 12 is configured to analyze these images to detect pests and determine their location parameters. These parameters can be used to direct the laser beam 10 from the laser unit 9 onto the targeted pests via the movable mirror 13. In some embodiments, the laser unit 9 may include an actuator, which directly aligns the laser beam 10 without relying on the movable mirror 13 or directs the laser beam 10 onto a fixed mirror for targeting.

The aerial vehicle 1 may also be suitable for military applications. In this context, the camera 7 may be configured to capture images of the environment, and the control unit 12 is configured to analyze these images to detect military targets, such as human eyes, and determine their location parameters. These parameters can then be used to direct the laser beam 10 from the laser unit 9 onto the military targets using the movable mirror 13. In some embodiments, the laser unit 9 may include an actuator, which directly aligns the laser beam 10 without relying on the movable mirror 13 or directs the laser beam 10 onto a fixed mirror for targeting.

The aerial vehicle 1 may further be suitable for burning weeds or leaves. In this application, the camera 7 may be configured to capture images of the environment, and the control unit 12 is configured to analyze these images to detect unwanted vegetation and determine their location parameters. These parameters can then be used to direct the laser beam 10 from the laser unit 9 onto the weeds or leaves using the movable mirror 13. In some embodiments, the laser unit 9 may include an actuator, which directly aligns the laser beam 10 without relying on the movable mirror 13 or directs the laser beam 10 onto a fixed mirror for targeting.

FIG. 2 shows a schematic illustration of the interaction between the laser unit 9, the camera 7 and the optical unit 11 in a preferred embodiment of the aerial vehicle 1. The schematic illustration corresponds, for example, to the aerial vehicle 1 shown in FIG. 1.

The laser unit 9 may comprise a fiber 27 coupled laser light source 33 and a collimating lens 23. The collimating lens 23 may ensure that the laser light emitted from the fiber 27 is converted into a parallel laser beam 10. It is apparent that the laser beam 10, as it exits the fiber 27, may initially be diverge or widen before being collimated by the collimating lens 23. The optical unit 11 may include a means for converging the laser beam 10, which, in some embodiments, may be realized as a converging lens 25.

The converging lens 25 may have in some examples a dynamic focal length, allowing the focus point of the laser beam 10 to be adjusted based on the distance to the target 21.

In some embodiments where the laser unit 9 may comprise multiple laser sources 33 emitting multiple laser beams 10, the converging means may allow the multiple laser beams 10 to be focused to a single point at a defined distance.

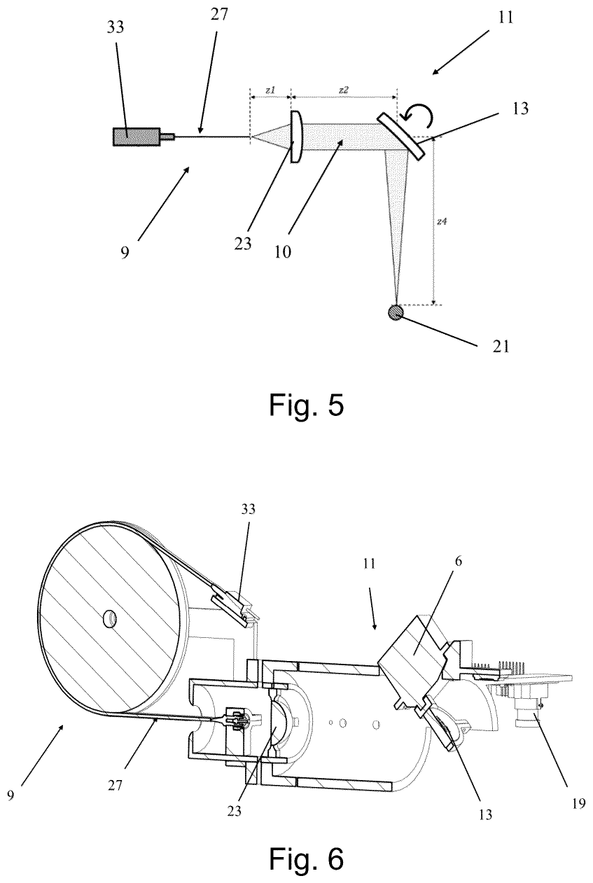

Instead of a converging lens 25, the converging means may also be implemented in alternative embodiments as a movable mirror 13, preferably configured as a concave mirror (see, for example, FIG. 5). The movable mirror 13 may be dynamically adjusted to alter the focus point by modifying its orientation or curvature, enabling precise targeting of the laser beam 10 generated by the laser unit 9.

The laser beam 10 may be directed onto a dichroic mirror 15, which may be part of the optical unit 11. Additionally, the camera 7 is preferably positioned such that its optical path can also be directed onto the dichroic mirror 15. The dichroic mirror 15 may be configured to reflect the laser beam 10 while being transparent to the optical path of the camera 7, so that the optical path of the camera 7 may be aligned with the path of the laser beam 10. In alternative embodiments, the dichroic mirror 15 may instead be configured to allow the laser beam 10 to pass through while reflecting the optical path of the camera 7.

Both the optical path of the laser beam 10 and the optical path of the camera 7 may be directed at the movable mirror 13. The movable mirror 13 may redirect the laser beam 10 onto a target 21, utilizing data provided by a control unit 12. The control unit 12 may process input from the camera and/or various sensors to calculate the optimal orientation of the movable mirror 13. The target 21 may, for example, be an insect, but alternative targets are also possible depending on the application.

The alignment of the laser beam 10 and the camera's optical path via the dichroic mirror 15 may improve precise targeting with a compact arrangement and reducing computing resources, as it enables the system to use the same line of sight for both detecting targets 21 and directing the laser beam 10. The dichroic mirror 15 may ensure that the laser beam 10 is reflected while the camera's 7 optical path passes through, or vice versa, aligning both paths to a common axis. Preferably, the camera's 7 focal point is also precisely aligned with the focal point of the laser beam 10. Once a target 21 is detected and sharply focused in the camera's 7 image, it can be reliably assumed that the target 21 is also in the focus of the laser beam 10, triggering its emission.

Preferably, the movable mirror 13 is adjustable in at least one degree of freedom through an actuator. The actuator may, for example, be a servo motor 6. A sensor, which may optionally be part of the optical unit 11, can monitor the position or changes in the position of the movable mirror 13. The degree of freedom may include the pitch or roll of the movable mirror 13, allowing precise adjustments to its orientation based on control data. The sensor may, optionally, be embedded in the servo motor 6.

The actuator may be coupled to the movable mirror 13 via a pulling cable or a wire. Alternatively, the movable mirror 13 may be coupled to a spring, rubber, or flexible structure. The spring, rubber, or flexible structure may be configured to apply a constant rotational force to the movable mirror 13. The rotational force may be selected from the group consisting of pitch rotational force and roll rotational force relative to the movable mirror 13. This configuration allows precise adjustments of the laser beam 10 generated by the laser unit 9 and directed through the optical unit 11 towards the target 21.

In a further preferred embodiment, the movable mirror 13 may be actuated by a second servo motor 6 to enable adjustments along at least one additional degree of freedom. The additional degree of freedom may be selected from the group consisting of pitch and roll of the movable mirror. This configuration allows the movable mirror 13 to achieve more precise positioning and targeting of the laser beam 10, improving its ability to accurately direct the beam 10 onto the target 21. The integration of the second servo motor 6 may be controlled by the control unit 12, which processes sensor data, such as positional feedback from the optical unit 11 or external environmental inputs, to optimize the alignment of the movable mirror 13. In this document we define Fast steering mirror as a mechanism that can alter two rotation degrees of freedom of a movable mirror, hence this mirror coupled to two servos makes it a fast steering mirror mechanism.

In a further preferred embodiment, the optical unit 11 may comprise a galvo steering system, with the movable mirror 13 forming part of it. A galvo steering system generally uses galvanometer motors to adjust the angle of mirrors rapidly and precisely, enabling dynamic beam steering. The system is particularly suitable for applications requiring high-speed tracking or precise targeting, such as neutralizing small or moving pests.

In a further preferred embodiment, the optical unit 11 may further comprise a means for preventing ambient light from passing through or being reflected by the dichroic mirror 15 and impinging upon a sensor of the camera 7. This means may include a material composed of a dark, light-absorbing substance designed to reduce unwanted reflections, or a second material, such as a metal foil, configured to block the transmission of light. These materials may be strategically positioned within the optical unit 11 to ensure that only the desired optical path reaches the camera 7, thereby enhancing the accuracy and reliability of image capture by minimizing interference from ambient light sources.

In a further preferred embodiment, the movable mirror 13 may comprise a mirror surface divided into a central zone and an outer zone. The central zone may be specifically configured to reflect the at least one laser beam 10 and may comprise a first mirror type optimized for high reflectivity and precision to ensure the accurate direction of the laser beam 10. Surrounding the central zone, the outer zone may be configured to reflect the field of view of the camera 7 and may comprise a second mirror type, which may be different from the first mirror type.

The first mirror type may exhibit higher optical quality than the second mirror type, providing enhanced accuracy for laser beam targeting. In contrast, the second mirror type may be designed to be lighter in weight than the first mirror type, reducing the overall load on the actuator and improving the responsiveness of the movable mirror 13. This configuration allows the movable mirror to efficiently balance precision and weight optimization, enabling both accurate laser targeting and effective image capture by the camera 7.

It is apparent from the context of the application that additional lenses and mirrors can be incorporated into the optical path of the laser beam 10 or the camera 7 to further adjust the optical paths.

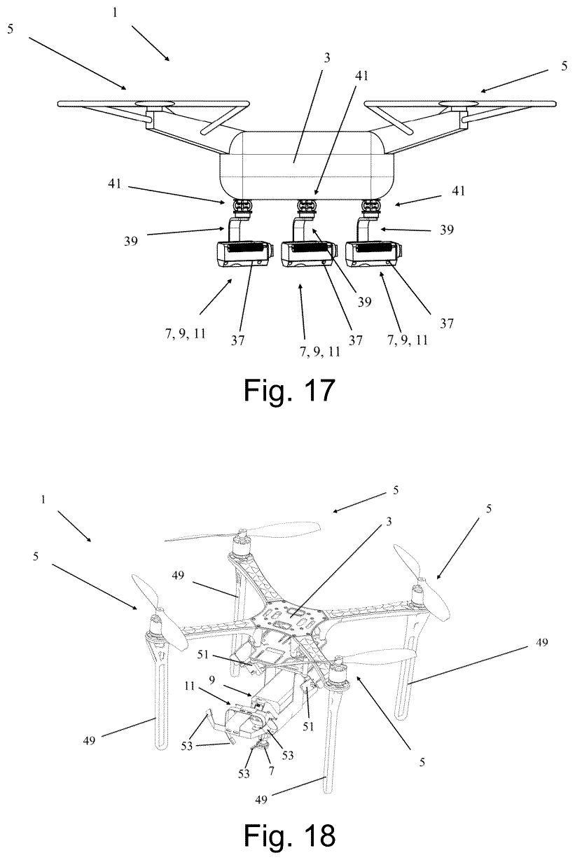

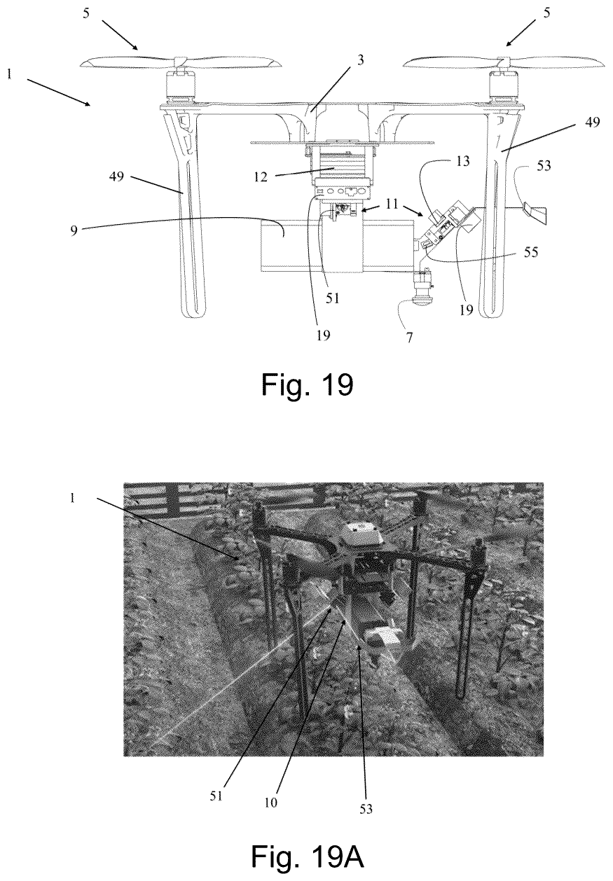

In a further preferred embodiment, the optical unit 11 may comprise a first movable mirror 13 and second movable mirror 13, each capable of operating independently and in parallel such that the first mirror 13 can direct the optical path of a first laser beam 10 and the camera 7 towards a first target 21, while the second mirror 13 can direct the optical path of the first laser beam 10, a split of version of the first laser beam 10, or a second laser beam 10, and an additional camera 7 towards a second target 21. This is shown in the embodiments from FIGS. 17 and 19.

In a further preferred embodiment, the movable mirror 13 may be positioned close to the dichroic mirror 15, the movable mirror 13 having a neutral position oriented at an angle of approximately 90 degrees relative to the dichroic mirror 15, thereby enabling a smaller movable mirror 13 to achieve the desired field of view for the camera 7.

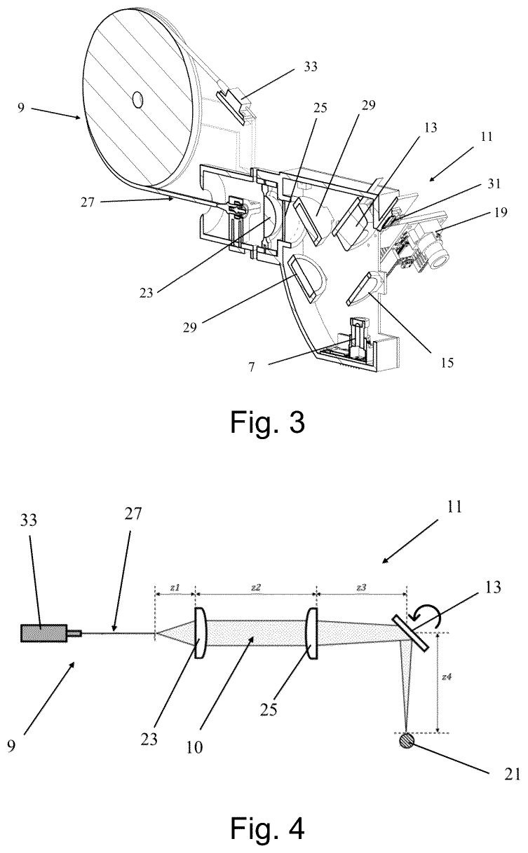

FIG. 3 shows essentially the schematic illustration presented in FIG. 2 in greater detail, depicted here as a 3D model in a sectional view. It corresponds to the embodiment from FIG. 1. In contrast to FIG. 2, two deflection mirrors 29 have been added. This deflection mirrors may redirect the laser beam 10 from the converging lens 25 to the dichroic mirror 15. The inclusion of the deflection mirrors 29 provides greater flexibility in arranging the laser unit 9 relative to the optical unit 11. Specifically, the laser unit 9 or the laser exit point of the laser unit 9 does not need to be positioned at the same height as the dichroic mirror 15, allowing for more versatile system designs. Other configurations are also conceivable, such as using more deflection mirrors 29 (for example three or four) or fewer, such as just one deflection mirror 29.

FIG. 4 shows a schematic illustration of the interaction between the laser unit 9, and the optical unit 11 in a further preferred embodiment of the aerial vehicle 1. In this embodiment, the aerial vehicle 1 may comprise a main body 3 with at least one thrust producing means 5, and a camera 7 for capturing images of an environment (both are not depicted in the schematic illustration of FIG. 4). The camera 7 can, for example, be a stereo camera 19.

Further, the aerial vehicle 1 may comprise a laser unit 9 for emitting a laser beam 10. The laser unit 9 may comprise a fiber 27 coupled to a laser light source 33 with a collimating lens 23.

The optical unit 11 may comprise a converging lens 25 and a movable mirror 13, at which the laser beam 10 can be aimed to direct the laser beam onto a target 21. The movable mirror 13 is preferably coupled to an actuator and may be movable in at least one degree of freedom.

In this embodiment, the aerial vehicle 1 may include a control unit 12, which is preferably connected to the camera 7. The control unit 12 can be configured to analyze the images captured by the camera 7 to detect objects and determine their location parameters. These parameters may then be used to direct the laser beam 10 onto targeted objects, such as the target 21.

The actuator may comprise a rotary motor assembly configured to steer the laser beam 10. This assembly can include a rotary motor coupled to the movable mirror 13, where the motor is configured to rotate the movable mirror 13 in response to an applied signal. An integrated driver circuit may be three-dimensionally stacked with at least one component of the rotary motor. The integrated driver circuit may incorporate advanced features, such as through-silicon vias (TSVs) for vertical electrical connections, a silicon interposer for interconnecting stacked dies, and wafer-level packaging (WLP). At least one component of the rotary motor assembly may be fabricated from lightweight materials, such as titanium or aluminum, to reduce weight and enhance efficiency. Furthermore, the rotary motor may optionally comprise a piezoelectric motor for precise and responsive control of the movable mirror 13.

The orientation of the camera 7 may define a field of view. Within this field of view, the laser beam 10 can be directed by adjusting the movable mirror 13. The control unit 12 may be configured to control the movable mirror 13 such that the laser beam 10 can precisely target a specific target 21 located within the field of view of the camera 7. Like FIG. 8 and embodiment of FIG. 24.

FIG. 5 shows a schematic illustration of the interaction between the laser unit 9, and the optical unit 11 in a further preferred embodiment of the aerial vehicle 1. This embodiment is substantially the same as that shown in FIG. 4, the difference being the removal of the converging lens 25 from the configuration. The function of the converging lens 25 is now performed by the movable mirror 13, which is in the form of a concave mirror. The concave mirror 13 may focus the expanded parallel laser beams 10 onto a target 21.

FIG. 6 shows a more detailed representation of the schematic illustration presented in FIG. 5, depicted here as a 3D model in a sectional view. In addition to the components described in connection with FIG. 5, a component of the stereo camera 19 is also visible. The stereo camera 19 may capture images of the environment, which are analyzed by the control unit 12. Based on this analysis, the movable mirror 13 directs the laser beam 10 accordingly. In this regard, the movable mirror 13 may be actuated by a servo motor 6, allowing it to move in at least one degree of freedom.

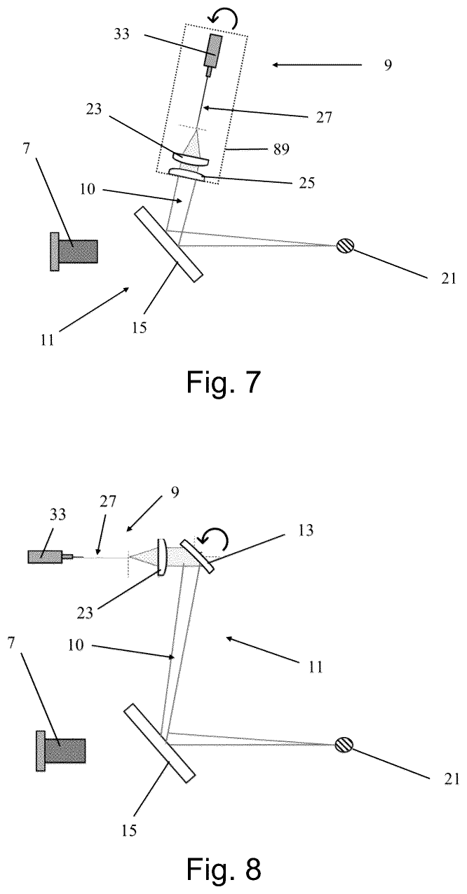

FIG. 7 shows a schematic illustration of the interaction between the laser unit 9, the camera 7 and the optical unit 11 in a further preferred embodiment of the aerial vehicle 1. The laser unit 9 may comprise a fiber 27 coupled to a laser light source 33 and a collimating lens 23. The collimating lens 23 can ensure that the laser light emitted from the fiber 27 is converted into a parallel laser beam 10. It is apparent that the laser beam 10 initially expands upon exiting the fiber 27.

The optical unit 11 may include a means for converging the laser beam 10, which, in certain embodiments, can be implemented as a converging lens 25.

The laser beam 10 may be directed onto a dichroic mirror 15, which may be part of the optical unit 11. Additionally, the camera 7 is preferably positioned such that its optical path can also be directed onto the dichroic mirror 15. The dichroic mirror 15 may be configured to reflect the laser beam 10 while being transparent to the optical path of the camera 7, so that the optical path of the camera 7 may be aligned with the path of the laser beam 10. In alternative embodiments, the dichroic mirror 15 may instead be configured to allow the laser beam 10 to pass through while reflecting the optical path of the camera 7.

In some embodiments, the laser unit 9 may include an actuator for directing the laser beam 10 toward the dichroic mirror 15. Preferably, the laser light source 33, the fiber 27, the collimating lens 23, and/or the converging lens 25 may form a structural unit. This structural unit can be implemented within a housing 89, in which the laser light source 33, the fiber 27, the collimating lens 23, and/or the converging lens 25 may be integrated. The housing 89 itself may be movable in at least one degree of freedom by means of an actuator, enabling the emitted laser beam 10 to be precisely directed.

By aligning the laser beam 10 with the dichroic mirror 15, the beam's orientation toward a target 21 is also controlled. The aerial vehicle's control unit 12 may process input from the camera 7 and/or various sensors to calculate the optimal orientation of the laser beam 10 or the laser light source 33. The target 21 may, for example, be an insect, although other targets are possible depending on the specific application.

For clarification, the laser unit 9, the optical unit 11, the camera 7, and the control unit 12 refer preferably to distinct functional units of the aerial vehicle. Each unit is preferably designed to perform a specific task. These units may either be physically integrated into a single housing or distributed as separate components, depending on the specific system configuration. Their modular design allows for flexibility in assembly, maintenance, and potential upgrades.

FIG. 8 shows a schematic illustration of the interaction between the laser unit 9, the camera 7, and the optical unit 11 in a further preferred embodiment of the aerial vehicle 1. The embodiment depicted in FIG. 8 largely corresponds to the embodiment shown in FIG. 7. However, instead of the laser unit 9 comprising an actuator that enables the laser beam 10 to be directed at a controlled angle onto the dichroic mirror 15, the laser unit 9 is now fixedly positioned and directs the laser beam 10 onto a movable mirror 13.

In all embodiments involving the interaction between a dichroic mirror 15, a camera 7, and a laser unit 9, the positions of the laser unit 9 and the camera 7 may be interchangeable. In such cases, it can preferably be necessary to adjust the light transmission properties of the dichroic mirror 15. Specifically, the dichroic mirror 15 may reflect the optical path of the camera 7 while allowing the laser beam 10 to pass through in the swapped positions. Conversely, when the laser unit 9 and the camera 7 are in their original positions, the dichroic mirror 15 can be configured to reflect the laser beam 10 and allow the optical path of the camera 7 to pass through.

The movable mirror 13 deflects the laser beam 10 at any desired angle onto the dichroic mirror 15. The movable mirror 13 may be designed as a concave mirror, such that the laser beam 10 is focused at a single point when exiting the optical unit 11. Ideally, this focal point corresponds to the target 21, such as an insect.

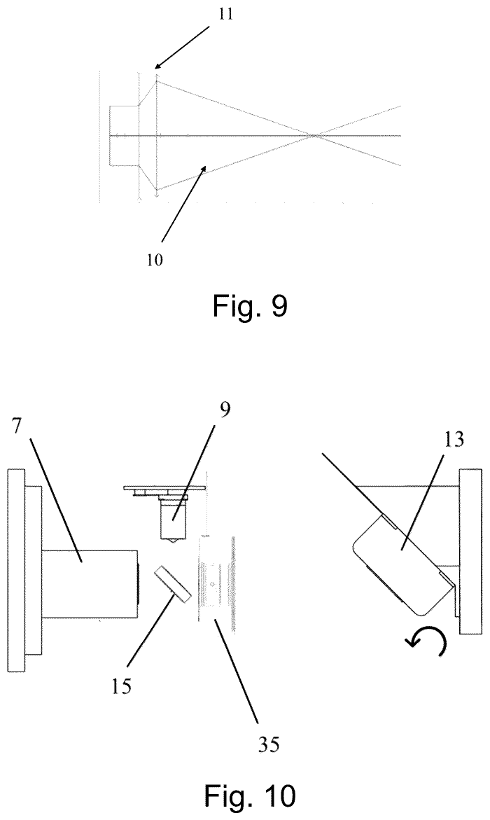

FIG. 9 shows a schematic illustration of a laser beam 10 exiting an optical unit 11 equipped with a means for converging the laser beam 10. This configuration offers significant safety advantages, particularly for human eye safety, as the laser beam 10 diverges beyond the focal point, resulting in a reduction of energy intensity. Consequently, areas beyond the focal point are not at significant risk. At the focal point, however, the laser beam 10 is highly concentrated, enabling precise targeting and maximum effect at that specific location.

The laser unit 9 may comprise multiple laser light sources 33 for emitting multiple laser beams 10 in some embodiments. In this case, the laser light sources 33 can be implemented on an integrated laser chip or as an array. A single laser driver circuit may be configured to control and drive the multiple laser light sources 33 efficiently. The converging means of the optical unit 11, such as a converging lens 25, may focus the multiple laser beams 10 to a single point, ensuring precise targeting and maximizing the combined energy at the focal point.

Generally, the control unit 12 plays an important role in the aerial vehicle 1. It can be configured to analyze the images captured by the camera 7, potentially using artificial intelligence algorithms, such as convolutional neural networks, to detect objects and determine their location parameters. Preferably, these location parameters may be aligned with the focal point of the laser beam 10 to enable precise targeting.

In a further preferred embodiment, the control unit 12 may be configured to detect the presence of any human within a nominal hazard zone of the laser beam 10. The aerial vehicle 1 may optionally include sideward-facing cameras 18, possibly infrared sensitive, to provide comprehensive coverage of the hazard zone and to enhance the detection capabilities. The nominal hazard zone can be defined as a zone with a radius of 40 meters from the movable mirror 13. In additional examples, the nominal hazard zone may have a radius selected from a range of 5 meters to 100 meters, preferably from a range of 20 meters to 80 meters, and particularly from a range of 30 meters to 60 meters.

In this embodiment, the control unit 12 may be further configured to control the laser unit 9 or the optical unit 11 in such a way that it does not target any objects outside an active operating window. The active operating window maybe located at the center of the nominal hazard zone and may define the area where the laser may be safely operated. If a human is detected within the nominal hazard zone, the control unit 12 may cease neutralizing potential targets to ensure safety.

The control unit 12 may be configured to analyze the images captured by the camera 7 for anomaly detection, potentially using artificial intelligence algorithms to identify deviations from expected patterns. Additionally, the laser unit 9 may be configured to deactivate if water droplets or other reflective surfaces are detected, as these could unpredictably deflect the laser beam 10.

In a further preferred embodiment, the control unit 12 may be configured to execute a location prioritization algorithm. This algorithm can select locations for targeting insects based on the frequency of previous encounters with target insects at those locations. Alternatively, the algorithm may be executed on a remote server, with the prioritization data transmitted to the control unit 12 for implementation.

In a further preferred embodiment, the control unit 12 may be configured to store information about previous encounters with target insects at various locations within the operational area of the aerial vehicle 1. In this respect, the location parameters of targeted objects may be stored in a database present in the memory. Alternatively, this database and the associated processing may reside on a remote server, with the control unit 12 receiving processed data for implementation. Based on this stored information, the control unit 12 can estimate an insect emergence rate for each location. Using these estimated rates, the control unit may select specific locations for targeting insects, preferably prioritizing areas with higher estimated emergence rates. This configuration enhances the efficiency and effectiveness of the targeting system.

In a further preferred embodiment, the aerial vehicle 1 may comprise a plurality of independently operable beam-steering mirrors or movable mirrors 13 within the optical unit 11. In this respect, the control unit 12 can configured to predict trajectories of a plurality of target objects 21 relative to the main body 3 and to assign each target object 21 to one of the plurality of beam-steering mirrors or movable mirrors 13 based on a cost function that minimizes total mirror movement.

In a further preferred embodiment, the control unit 12 may be configured to perform a cluster analysis on the location parameters of a plurality of target objects to identify target-rich zones. Based on this analysis, the control unit 12 can generate an optimized flight path for the aerial vehicle 1, preferably prioritizing the identified target-rich zones. The optimized flight path may be determined using a cost function that minimizes at least one factor, such as the total distance traveled by the aerial vehicle 1, the total movement of the movable mirror 13, or a combination of these factors.

In a further preferred embodiment, the control unit 12 may be configured to perform a calibration process to determine an offset aiming point. This calibration process can address observed discrepancies between an intended aim point and the actual location of the laser spot or the focal point of the laser beam 10. Using this offset aiming point, the control unit 12 may adjust the laser aiming to account for potential misalignments between the dichroic mirror 15, the laser unit 9, and/or the camera 7.

The functional interaction between the control unit 12, the camera 7, the laser unit 9, and/or the optical unit 11 enables the aerial vehicle 1 to target an object and emit a laser beam 10 at the targeted object while moving through a spatial environment.

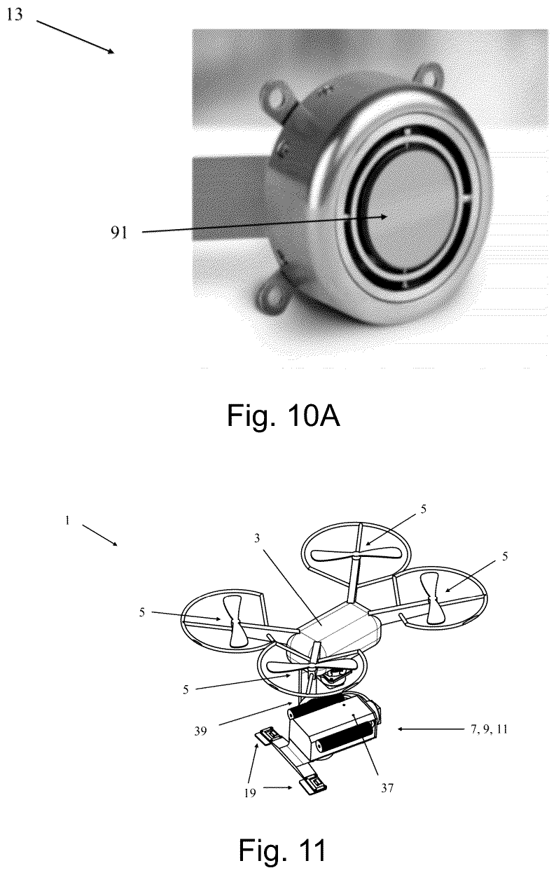

FIG. 10 shows a schematic illustration of the interaction between the laser unit 9, the camera 7 and the optical unit 11 in a further preferred embodiment of the aerial vehicle 1. Unlike the previously described embodiments, the embodiment depicted in FIG. 10 includes a liquid lens 35 as converging means. This liquid lens 35 introduces enhanced flexibility in focusing, as its focal length can be dynamically adjusted by varying the electrical input. This feature enables precise targeting across varying distances and improves the overall adaptability of the system in dynamic environments. The movable mirror 13 may be a Fast Steering Mirror as depicted in FIG. 10A.

FIG. 10A shows a preferred embodiment of a movable mirror 13. The movable mirror may be designed as a Fast Steering Mirror. A Fast Steering Mirror (FSM) is preferably a high-precision optical device used to dynamically adjust the angle of reflected light beams, such as laser beams 10. It may operate with rapid response times, allowing for real-time corrections in beam alignment, stabilization, or pointing.

At its core is a lightweight, highly reflective mirror 91, often mounted on a flexible suspension system to allow controlled tilting in two axes (X and Y). Actuators, such as piezoelectric or voice-coil actuators, may drive the mirror's 91 movement with high speed and precision. Integrated position sensors may monitor the mirror's 91 orientation in real-time, providing feedback to a control unit that ensures accurate and stable operation. The entire system 13 is typically enclosed in a protective housing to shield it from environmental factors like dust and vibration. Generally, a mechanism that allow controlled tilting in two axes can be defined as a Fast Steering Mirror.

FIG. 11 shows a further preferred embodiment of the aerial vehicle 1. Preferably, the optical unit 11, the laser unit 9 and the camera 7 may be arranged in a common housing 37 which is attached to the main body 3 via a gimbal 39, isolating the optical unit 11, the laser unit 9 and the camera 7 from the roll and pitch movements of the main body 3.

The gimbal 39 may be coupled to the main body 3 via a flexible structure 41, such as a wire rope isolator, isolating the optical unit 11, the laser unit 9 and the camera 7 from frequency horizontal and vertical vibrations of the main body 3.

In a further preferred embodiment, the gimbal 39 may comprise at least two rotational axes, with actuators configured to allow the housing 37 to rotate about these axes. This arrangement can enable the optical unit 11 to be coarsely oriented toward a potential target 21. Additionally, the movable mirror 15 within the optical unit 11 may perform fine adjustments to align either the optical path of the camera 7 or the laser beam 10 with greater precision. Further, the optical unit 11 may be iteratively directed at specific subregions of an area beneath the aerial vehicle 1, allowing it to scan and address each subregion in succession.

In a further preferred embodiment, the housing 37 may comprise multiple exit openings through which the laser beam 10 can be directed out of the housing 37 via the movable mirror 13. Further preferred a stereo camera 19 may be coupled to the housing 37.

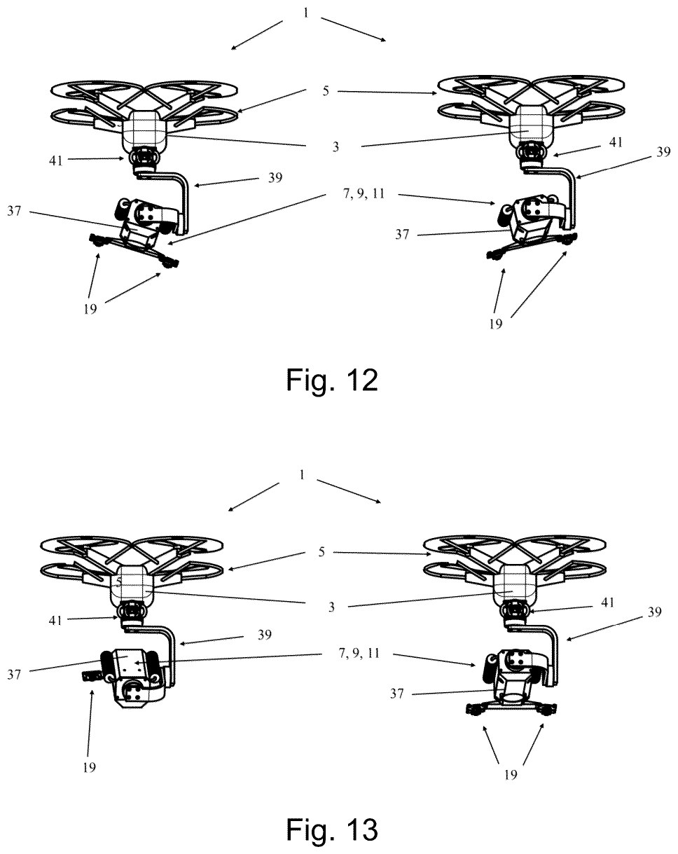

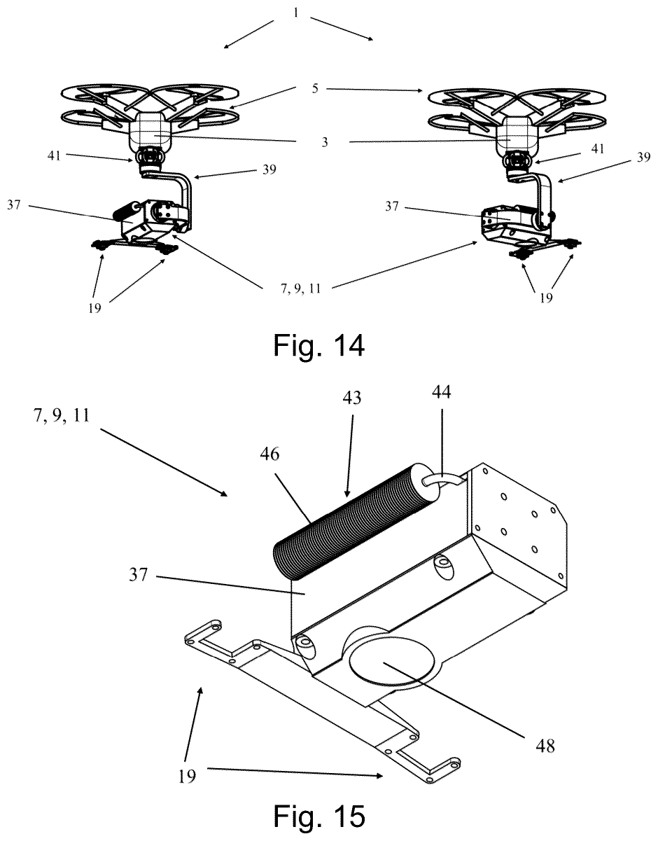

FIG. 12, FIG. 13, and FIG. 14 illustrate the embodiment depicted in FIG. 11, highlighting the housing 37 degrees of freedom via gimbal 39. These degrees of freedom allow the housing 37 to move along the roll, pitch, and yaw axes. Specifically, FIG. 12 demonstrates the roll motion, FIG. 13 depicts the pitch motion, and FIG. 14 illustrates the yaw motion. This dynamic range of movement provided by the gimbal 39 facilitates precise positioning of the optical unit 11 which is located in the housing 37.

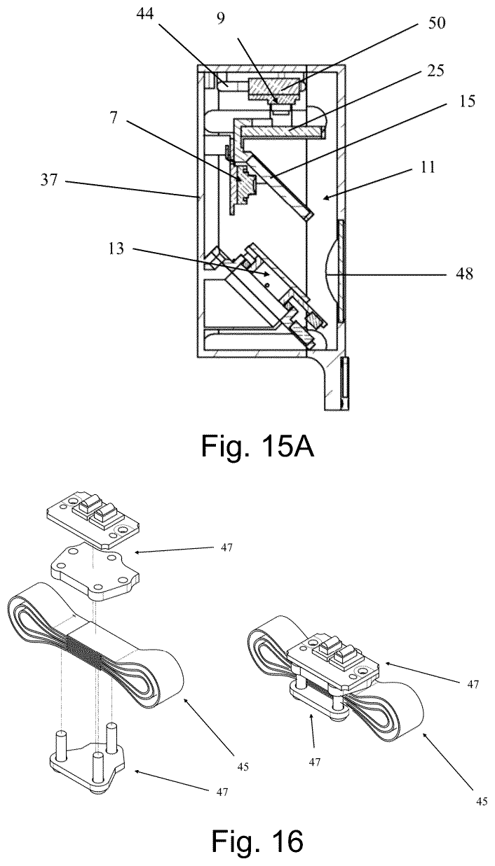

FIG. 15 shows a detailed view of the housing 37 of the embodiment illustrated in FIGS. 11-14. A cooling unit 43 may be coupled with the laser unit 9 which is incorporated in the housing 37. The cooling unit 43 may employ graphene or diamond material, allowing to dissipate heat generated by the laser beam 10 away from the laser unit 9. These materials may be arranged in sheets 46 or ribs 87 to optimize heat transfer and enhance cooling efficiency (see also FIG. 25).

In this context, the heat can be transferred to a high-wind region generated by at least one thrust producing means 5. Preferably, the cooling unit 43 may be partially or entirely positioned outside the housing 37, while being securely attached to it. Additionally, means may be provided to transfer heat from the laser unit 9 to components of the cooling unit 43 in a simple and efficient manner. For instance, the cooling unit 43 can include a heat pipe 44, which transfers heat from the laser unit 9 as the heat source to components of the cooling unit located outside the housing 37. The goal is to redistribute heat concentrated on a small surface area to a component with a larger surface area, such as ribs 87 or sheets 46 connected to the heat pipe 44, to enhance heat dissipation.

The cooling unit 43 may further comprise a liquid reservoir, suitable to contain water or ammonia, allowing the heat to buffer and to release in periods of low laser firing. The capacity of the liquid reservoir can be for example less than 300 cm³.

The stereo came 19 is shown schematically in FIG. 15 by its holder on the housing 37.

FIG. 15A shows a cross section of the housing 37 illustrated in FIG. 15. Within the housing 37, a camera 7, a laser unit 9, and an optical unit 11 may be located. The optical unit 11 can preferably include a dichroic mirror 15 and a movable mirror 13, which may, for example, be designed as a Fast Steering Mirror. The camera 7 may be directed toward the dichroic mirror 15, which can reflect the optical path of the camera 7 onto the movable mirror 13. On the other side, the laser unit 9 may be directed toward the dichroic mirror 15, which can be configured to transmit the laser beam 10 or its wavelength. This arrangement may ensure that the optical path of the camera 7 and the optical path of the laser beam 10 are aligned and overlap. The movable mirror 13 may then direct the laser beam 10 and the optical path of the camera 7 outside the housing 37 through a window 48. The window 48 can preferably be made of glass or plastic.

The laser unit 9 may be thermally coupled to a vapor chamber 50, which can preferably include a wick structure made from a material selected from the group consisting of sintered copper powder or a composite wick comprising at least one layer of sintered copper powder. The vapor chamber 50 may be configured to distribute the heat generated by the laser unit 9 over a larger surface area, thereby enhancing heat dissipation.

The vapor chamber 50 may be coupled to the heat pipe 44, which can preferably transfer the heat outside the housing 37.

FIG. 16 illustrates a further embodiment of how components of the cooling unit 43 can be designed. In this embodiment, instead of using ribs 87 or sheets 46, the graphene or diamond material may be arranged in overlapping layers or sheets, which are further shaped into loops 45. These loops 45 may be clamped securely between two clamping elements 47. The clamping elements 47 may transfer the heat generated by the laser unit 9 to the loops 45, which then dissipate the heat efficiently into the surrounding environment. This configuration is shown in FIG. 16 both as an exploded view and in an assembled state.

FIG. 17 shows a further preferred embodiment of an aerial vehicle 1. The aerial vehicle 1 may include a main body 3 with at least one thrust-producing means 5, preferably four thrust-producing means 5. Additionally, it can preferably include three housings 37, each of which may house a laser unit 9, an optical unit 11, and a camera 7. These components may act as independent modules and can preferably target different objectives 21 independently using laser beams 10. Alternatively, the laser unit 9, optical unit 11, and camera 7 may be integrated under the same gimbal, enabling coordinated movement and targeting for all components.

Each housing 37 may be mounted to the main body 3 of the aerial vehicle 1 via a gimbal 39 and a flexible structure 41. The aerial vehicle 1 can preferably include a control unit 12 comprising a processor, a memory, and one or more communication units, which may be in data communication with the laser unit 9, the camera 7, and the optical unit 11 of each module. The control unit 12 may be configured to analyze the images captured by the cameras 7 to detect objects and optionally determine their location parameters, which can preferably be used to individually direct the laser beam 10 of each module onto targeted objects. The modules may emit the laser beams 10 sequentially or simultaneously to target objects as required.

FIGS. 18 and 19 illustrate another preferred embodiment of the aerial vehicle 1 from different perspectives. The aerial vehicle 1 may comprise a main body 3 equipped with four thrust-producing means 5, such as propellers. Support members 49 may be attached to the main body 3 to enable the aerial vehicle 1 to stabilize when placed on a surface. These support members 49 are preferably designed to allow a variety of components, such as a laser unit 9, camera 7 and an optical unit 11, to be mounted beneath the main body 3.

The laser unit 9 may preferably comprise a high-power diode laser, such as a 70 W diode laser, serving as the light source. The optical unit 11 may include a galvo steering system, which could comprise at least one movable mirror 13. Some embodiments may use a mirror 55 or other light guiding means such as a fiber 27 to direct the laser light into the galvo system. The galvo steering system may steer the laser beam 10 in a forward-downward direction to facilitate interaction with the area below the aerial vehicle 1. Additionally, the galvo system could redirect the laser beam 10 onto small mirrors 53. These mirrors 53 may reflect the laser beam 10 into the inputs of additional galvo systems 51. These additional galvo systems 51 could then be positioned to emit the beam towards the left and right undersides of the aerial vehicle 1, respectively (see also FIG. 19A).

The camera 7 may be used to perform target insect scouting operations where the aerial vehicle 1 flies higher above the agricultural field and takes pictures allowing it to make a database of known insect locations.

Furthermore, the embodiment may contemplate the incorporation of one or more sensing systems for each galvo system direction. These sensors may provide visual or depth information about the surrounding environment. An example for such sensing system may comprise a stereo camera 19.

The aerial vehicle 1 may comprise a control unit 12, which can be coupled to the laser unit 9, the optical unit 11, i.e. the galvo steering systems, and/or the camera 7, as well as other sensing systems. Based on the analysis of the captured images and data from the sensing systems, the control unit 12 can control the galvo steering systems such that an emitted laser beam 10 accurately targets corresponding objectives 21.

FIG. 19A shows a preferred embodiment of the aerial vehicle 1 illustrated in FIGS. 18 and 19, depicted in an operating state where the laser beam 10 is emitted from the aerial vehicle 1. As already described, the generated laser beam 10 may be directed onto small mirrors 53 via the galvo system. These mirrors 53 may reflect the laser beam 10 into the inputs of additional galvo systems 51. These additional galvo systems 51 can then be configured to emit the laser beam 10 towards the left and right undersides of the aerial vehicle 1, respectively.

Preferably, the vehicle may comprise multiple movable mirrors 13, wherein each is capable of operating independently and in parallel such that the first mirror 13 can direct the optical path of a first laser beam towards a first target 21, while the movable second mirror 13 can direct the optical path of the first laser beam, a split of version of the first laser beam 10, or a second laser beam 10, and an additional camera towards a second target 21. In this respect, the first and the second movable mirrors 13 can be part of different galvo steering systems.

FIG. 20 illustrates another preferred embodiment of the aerial vehicle 1, which may be designed as a high-speed drone and/or as a long-range drone. This design may support a centralized, shared recharge or battery swap solution, where one central hub can efficiently supply and service multiple locations, such as farms.

The aerial vehicle 1 may comprise at least one wing 57 that generates lift when the vehicle 1 moves forward. The inclusion of wings allows for reduced power consumption, enabling extended flight ranges. Additionally, it may include a plurality of thrust-producing means 5, which can be configured as propellers. In the present embodiment, the configuration may involve five propellers, wherein four propellers 5′ are preferably designed to provide mainly vertical thrust, while a fifth propeller 5″ is configured to generate mainly horizontal thrust. Alternatively, at least one propeller 5 may be dynamically rearrangeable and configured to provide either vertical thrust or horizontal thrust, depending on operational requirements.

In a further preferred embodiment, the application relates to a system comprising the aerial vehicle 1 as described in the embodiments above, a designated landing area, and a mechanism for separating the replaceable battery 17 or replaceable battery assembly 69 from the aerial vehicle 1. The mechanism may be configured to autonomously reach the majority of locations within the designated landing area and is preferably not restricted by the length of the designated landing area. Additionally, the mechanism can autonomously approach the aerial vehicle 1 after it has landed and may separate the battery from the aerial vehicle 1 as part of a battery swap operation.

FIG. 21 shows a preferred embodiment of the battery 17 used in the aerial vehicle 1. The battery 17 may be integrated into a replaceable battery module 69 designed for ease of swapping. This battery module 69 may include a battery housing assembly and a battery socket assembly, which both comprises several components that facilitate secure attachment, reliable energy transfer, and efficient robotic swapping.

The battery housing assembly preferably includes a battery basket 58, which features a battery resting plate 59 to support the battery 17, four legs that may slide into the cut-away sections on the roof 63, for secure attachment, and permanent magnets 61, that may interact with corresponding magnets 61 in the battery socket assembly 65 to ensure stability. The roof 63 of the battery housing assembly may comprise cut-away sections to accommodate the legs of the battery basket 59. Securing pins, 66 and 67, may lock these legs in place, while a permanent magnet holder positioned on the top side of the roof 63 enables robotic gripping. Additionally, the roof 63 may incorporate conductive material on two sides, which serves as the electrical contact points for energy transfer. These conductive features align with the curled contact flaps in the battery socket assembly.

The battery socket assembly may include a base plate 65, which is designed to securely hold the battery basket 58 legs through dedicated leg receivers. The base plate 65 may also house a permanent magnet holder that attracts the magnets 61 in the battery housing assembly, ensuring a firm connection. Electrical contact features on the base plate may facilitate energy transfer, with curled conductive flaps (e.g., made of copper) that make contact with the conductive sides of the roof 63 for reliable electrical connections.

The integration of these components creates a cohesive system where the battery housing assembly and the battery socket assembly interact seamlessly. The battery 17 is placed within the battery basket 59, covered by the roof 63, and secured by the pins 66, 67. When inserted into the socket assembly, the battery housing assembly aligns with the base plate 65, guided by the interaction of the permanent magnets 61. The conductive sides of the roof 63 establish contact with the electrical contact flaps on the base plate 65, enabling energy transfer.

The operational process begins with the assembly of the battery 17 into the basket 59, which is then covered and secured by the roof 63. During insertion, the battery housing assembly is guided into the socket assembly, establishing a secure mechanical and electrical connection. Once connected, the aerial vehicle 1 operates using the battery's power. For battery swapping, an external robotic mechanism, equipped with an electromagnet, grips the permanent magnet holder in the battery housing assembly, removes it from the socket, and replaces it with a charged battery housing assembly.

Safety measures are integrated into the design to ensure secure operation. The permanent magnets 61 and the battery basket leg receivers in the base plate 65 ensure the battery housing assembly remains firmly attached during flight. The electrical contact flaps are designed to provide consistent and reliable connections while preventing short circuits. The permanent magnet holder in the roof 63 is robustly designed to withstand the forces exerted during robotic swapping operations, ensuring the integrity of the assembly throughout the process.

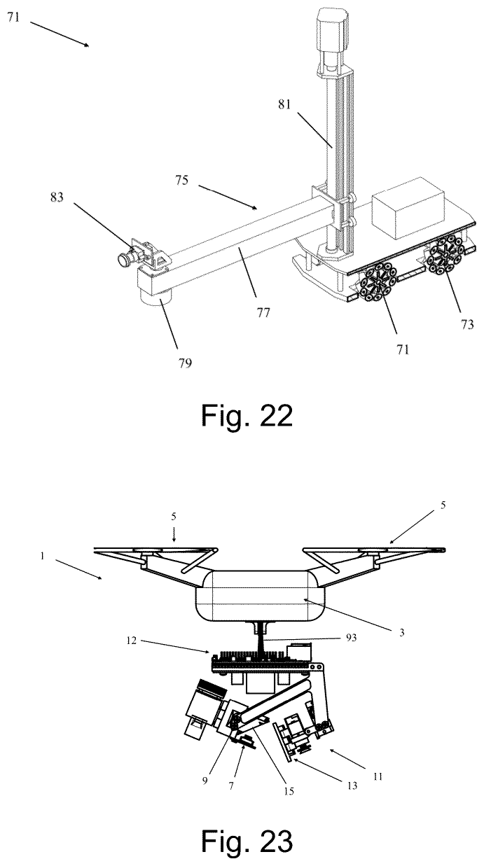

FIG. 22 illustrates a mechanism for separating the replaceable battery 17 from the aerial vehicle 1. The mechanism for separating the battery 17 may be attached to a robot 71, which can be equipped with wheels 73 or legs, making it suitable for navigating the designated landing area. In some embodiments, the wheels 73 may preferably be mecanum wheels or omni wheels, allowing for enhanced maneuverability.

Preferably, the battery 17 or the battery assembly 69 is detachably positioned on top of the aerial vehicle 1 when it is in a landed state. The battery 17 may include a magnet or metal component that can provide magnetic force to securely hold the battery 17 in place during flight and assist in its separation during the battery swapping process. Additionally, the mechanism for separating the replaceable battery 17 from the aerial vehicle 1 may comprise a battery-swapping component 75 designed to replace the battery 17. The battery-swapping component 75 may include an arm 77 equipped with an electromagnet 79, which can be moved vertically along a vertically arranged bar 81 via a rail and carriage system.

The robot 71 may preferably operate autonomously. To facilitate this, it may include a sensor, such as a camera 83, for driving and controlling the battery-swapping component 75. Furthermore, a rechargeable battery 85 and control unit may be integrated to operate the robot 71 and process data collected by the sensors, including camera 83 input, to ensure accurate positioning and efficient battery swapping.

In a further preferred embodiment, the aerial vehicle may be configured for maintenance. In this regard a notification may be generated indicating that the aerial vehicle requires maintenance. In a next step, a component of the aerial vehicle can be replaced with a new component.

FIG. 23 illustrates a further preferred embodiment of the aerial vehicle 1. The aerial vehicle 1 may include a main body 3 and a plurality of thrust-producing means 5. Coupled to the main body 3 via a rope 93 may be an alternative arrangement comprising a camera 7, a control unit 12, a laser unit 9, and an optical unit 11 with dichroic mirror 15 and a movable mirror 13. The rope 93 may preferably be configured to transfer yaw while isolating roll and pitch movements of the main body 3 of the aerial vehicle 1.

The laser unit 9 and the camera 7 are preferably rigidly connected to each other. Both the laser unit 9 and the camera 7 may be directed towards the dichroic mirror 15. The dichroic mirror 15 is preferably transmissive to the laser beam 10 and reflective to the optical path of the camera 7. This configuration ensures that the optical path of the camera 7 and the optical path of the laser unit 9, or laser beam 10, are aligned and both directed onto the movable mirror 13.

The control unit 12 may be configured to control the movable mirror 13 such that the laser beam 10 can precisely target a specific target 21.

FIG. 24 illustrates a further preferred embodiment of the arrangement involving the control unit 12, the laser unit 9, the optical unit 11, and the camera 7. The laser beam 10 and the optical path of the camera 7 can be aligned because the dichroic mirror 15 is positioned in between. This dichroic mirror 15 is preferably transparent to the optical path of the camera 7 while reflecting the laser beam 10. The laser beam 10 may be directed onto the dichroic mirror 15 via the movable mirror 13. The camera 7 and the laser unit 9 are preferably rigidly connected to each other. The laser unit 9 may comprise a laser driver 100 which may be coupled with the control unit 12.

The movable mirror 13 may be operatively coupled to two servo motors 6, enabling the movable mirror 13 to be adjusted in two dimensions (see also FIGS. 24A and 24B).

FIG. 24A and FIG. 24 B show a preferred embodiment of a movable mirror 13 coupled to two servo motors 6, allowing it to be adjusted in two dimensions. The servo motors 6 can preferably be interconnected via a hinge 52 and may function as the first and second servo motors 6. The first servo motor 6 may generate a rotational force on the hinge 52 that opposes the force exerted by a first rubber band 54 (the first rubber band 54 is shown with dashed lines). The second servo motor 6 may generate a rotational force on the hinge 95 that opposes the force exerted by a second rubber band 97 (the rubber band 97 is shown with dashed lines). The hinges 52 and 92 may have an axis of rotation perpendicular to each other.

The first rubber band 54 may be located between and connected the holes 56 and 58 on the mounting brackets of the servo motors 6 and the second rubber band 97 may be located between and connected the holes 99 and 101.

The rotational force on the hinges 52, 95 may be transmitted via a wire. A first wire can preferably be looped around or attached to a pulley 64 of the first servo motor 6 and then connected to hole 66 on the mounting bracket of the second servo motor 6. The second servo motor 6 may also include a pulley 62, with the a second wire routed around it and connected to the movable mirror 13 at hole 60. This configuration can enable precise movement of the movable mirror 13 through the coordinated actions of the two servo motors 6, offering enhanced control in two dimensions.

FIG. 25 shows a further preferred embodiment of the arrangement involving the laser unit 9, the optical unit 11, and the camera 7. This arrangement is particularly compact and may also include a cooling component, which can preferably be a part of the cooling unit 43. 43. The cooling unit 43 may be coupled with the laser unit 9, wherein the cooling unit 43 employs graphene or diamond material, allowing to dissipate heat generated by the laser beam away from the laser unit 9. These materials may be arranged in sheets 46 or ribs 87 to optimize heat transfer and enhance cooling efficiency (see also FIG. 15).

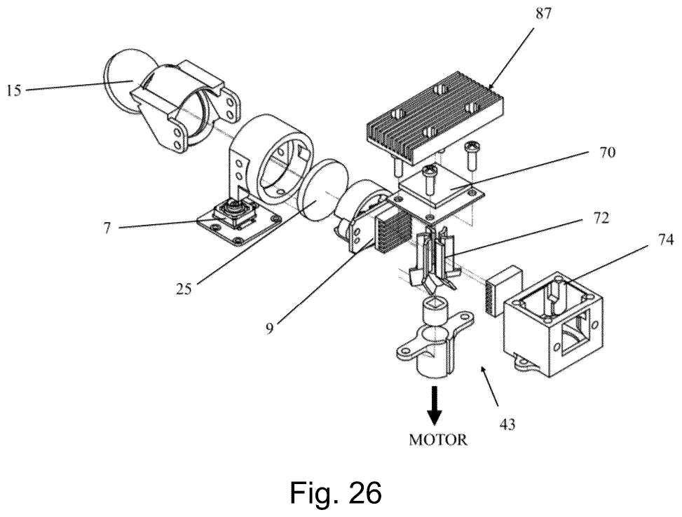

FIG. 26 shows a preferred embodiment shown in FIG. 25 in an exploded view, allowing the individual components to be seen in greater detail. The arrangement may include a laser unit 9, a camera 7, and a dichroic mirror 15. This configuration can enable a compact design. All components may preferably be housed within an enclosure, which can be assembled from multiple parts. The laser beam 10 and the optical path may exit the enclosure via the dichroic mirror 15 and can be directed onto a movable mirror 13, which, in turn, may guide both onto a target 21.

Additionally, a cooling unit 43 may be provided, which can preferably include a liquid reservoir 74 suitable for containing water or ammonia. The capacity of the liquid reservoir may, for example, be less than 300 cm³. Within the liquid reservoir 74, a water or liquid wheel 72 may be arranged, which can be driven by a motor. Furthermore, a Peltier element may be positioned above the liquid reservoir 74 to cool the liquid. Above the Peltier element, ribs 87 can preferably be placed to dissipate heat to the surrounding environment.

In some embodiments, the laser unit 9 may be equivalent to or synonymous with the laser light source 33.

The above embodiments in the application can also be described using the following Itemized lists.

The items of the first itemized list can be combined with one or more items of all other itemized lists in this document as well as with one or more features of the claims.

First itemized list:
1. An autonomously operating unmanned aerial vehicle, comprising:
   a. a main body with at least one thrust producing means, and
   a. a camera for capturing images of an environment, and
   b. a laser unit for emitting a laser beam, and
   c. a control unit with a processor, a memory and one or more communication units which are in data communication with the laser unit and the camera, wherein the control unit is configured to analyze the camera images to detect objects and determine their location parameters, which can be used to direct the laser beam onto targeted objects.
2. The aerial vehicle of item 1, wherein the laser unit comprises an actuator for directing the laser beam, or the aerial vehicle further comprises an optical unit with a movable mirror at which the laser beam can be aimed for directing the laser beam.
3. The aerial vehicle of item 1, further comprising a rotary motor assembly configured to steer the laser beam,
   wherein the rotary motor assembly comprises:
      rotary motor coupled to a mirror, the rotary motor being configured to rotate the mirror in response to an applied signal;
      an integrated driver circuit three-dimensionally stacked with at least one component of the rotary motor, wherein the integrated driver circuit comprises at least one of:
         through-silicon vias (TSVs) for vertical electrical connections;
         a silicon interposer for interconnecting stacked dies; and
         wafer-level packaging (WLP); and
   wherein at least one component of the galvo motor assembly is fabricated from a lightweight material selected from the group consisting of titanium and aluminium.
4. The aerial vehicle of item 3, wherein the rotary motor comprises a piezoelectric motor.,
5. The aerial vehicle of item 1, wherein the camera comprises a stereo camera.
6. The unmanned aerial vehicle of item 1, suitable for targeted pest control in an agricultural environment, wherein the stereo camera is configured to capture environmental images of the agricultural environment, and the control unit is configured to analyze the camera images to detect pests and determine their location parameters, which can be used to direct the laser beam onto targeted pests.
7. The unmanned aerial vehicle of item 1, suitable for military applications, wherein the stereo camera is configured to capture images of the environment, and the control unit is configured to analyze the camera images to detect military targets, such as human eyes, and determine their location parameters, which can be used to direct the laser beam onto military targets.
8. The unmanned aerial vehicle of item 1, suitable for burning weeds or leaves, wherein the camera is configured to capture images of the environment, and the control unit is configured to analyze the camera images to detect unwanted vegetation and determine its location parameters, which can be used to direct the laser beam onto the weeds or leaves.
9. The aerial vehicle of item 2, wherein the optical unit comprises a means to converge a laser beam or to focus multiple laser beams to a point in a distance when the laser unit comprises multiple laser sources for emitting multiple laser beams.

10. The aerial vehicle of item 2, wherein the movable mirror is movable in at least one degree of freedom via an actuator, the actuator being a servo motor, and wherein the optical unit or the laser unit comprises a sensor to monitor the position or positional change of the movable mirror or the laser unit.
11. The aerial vehicle of item 2, wherein the optical unit comprises a galvo steering system with the movable mirror being part of it.
12. The aerial vehicle of item 9, wherein the means to converge a laser beam or to focus multiple laser beams to a point in a distance is designed as follows:
   the optical unit comprises a converging lens, or
   the movable mirror is a concave mirror.
13. The aerial vehicle of item 9, wherein the converging lens has a dynamic focus length.
14. The aerial vehicle of item 2, wherein the optical unit, the laser unit, and the camera are arranged in a common housing, which is attached to the main body via a gimbal, isolating the optical unit, the laser unit, and the camera from the roll and pitch movements of the main body.
15. The aerial vehicle of item 14, wherein the gimbal is coupled to the main body via a flexible structure, such as a wire rope isolator, isolating the optical unit, the laser unit, and the camera from frequency horizontal and vertical vibrations of the main body.
16. The aerial vehicle of item 14, wherein the gimbal comprises at least two rotational axes with actuators allowing the housing to rotate about at least two axes, so that:
   the optical unit can be coarsely oriented with respect to a potential target, and fine adjustments to the alignment are made by the laser unit's actuator or the movable mirror of the optical unit, or
   the optical unit can be directed iteratively at specific subregions, scanning and targeting each subregion in succession.
17. The aerial vehicle of item 2, wherein the laser unit comprises at least one laser light source having a dominant wavelength of between 449 nm and 461 nm or between 798 nm and 818 nm.
18. The aerial vehicle of item 2, wherein the laser unit comprises multiple laser light sources for emitting multiple laser beams, wherein the laser light sources are implemented on an integrated laser chip or array.
19. The aerial vehicle of item 1, wherein the laser unit comprises a light source with a power of 5.5 W, and the light source is either a pulsed light source or a continuous one.
20. The aerial vehicle of item 1, wherein the laser unit comprises a fiber-coupled laser light source and a collimating lens.
21. The aerial vehicle of item 1, wherein the thrust-producing means comprises at least one propeller and the aerial vehicle further comprises at least one wing that generates lift when the vehicle moves forward.
22. The aerial vehicle of item 21, wherein the propeller is dynamically rearrangeable and configured to provide mainly vertical thrust or horizontal thrust.
23. The aerial vehicle of item 21, wherein the thrust-producing means comprises two propellers, wherein a first propeller is configured to provide mainly vertical thrust and a second propeller is configured to provide mainly horizontal thrust.
24. The aerial vehicle of item 1, further comprising a replaceable battery, wherein all power-consuming components on the vehicle are coupled to the battery as a power source.
25. The aerial vehicle of item 1, wherein the control unit is configured to analyze the camera images to detect objects and determine their location parameters using artificial intelligence algorithms, such as convolutional neural networks.
26. The aerial vehicle of item 25, wherein the control unit is configured to detect any human within a nominal hazard zone of the laser beam, and the aerial vehicle may comprise an infrared camera to enhance detection.
27. The aerial vehicle of item 26, wherein the nominal hazard zone is defined as a zone with a radius of 40 meters from the movable mirror, and the control unit is configured to control the laser unit such that it does not target any objects outside of the nominal hazard zone.
28. The aerial vehicle of item 27, wherein the control unit is configured to detect any human being within a nominal hazard zone of the laser beam, and the aerial vehicle may comprise an infrared camera to enhance detection.
29. The aerial vehicle of item 1, wherein the control unit is configured to analyze the camera images for anomaly detection, using artificial intelligence algorithms to identify deviations from expected patterns.
30. The aerial vehicle of item 29, wherein the laser unit is configured to deactivate when water droplets or other reflective surfaces are detected that could unpredictably deflect the laser beam.
31. The aerial vehicle of item 1, wherein the location parameters of targeted objects are stored in a database present in the memory.
32. The aerial vehicle of item 1, further comprising a cooling unit coupled with the laser unit, wherein the cooling unit employs graphene or diamond material to dissipate heat generated by the laser beam away from the laser unit.
33. The aerial vehicle of item 32, wherein the heat is transferred to a high-wind region generated by the at least one thrust-producing means.
34. The aerial vehicle of item 32, wherein the cooling unit comprises a liquid reservoir, suitable to contain water or ammonia, allowing the heat to buffer and release in periods of low laser firing, wherein the capacity of the liquid reservoir is less than 300 cm³.
35. The aerial vehicle of item 1, capable of targeting an object and emitting a laser beam at the targeted object while moving through a spatial environment.
36. The aerial vehicle of item 1, being configured for maintenance through the following steps:
   Generating a notification indicating that the aerial vehicle requires maintenance;
   Replacing a component of the aerial vehicle with a new component.
37. A drone swarm comprising a plurality of aerial vehicles according to item 1, wherein each aerial vehicle is in data communication with one another and can communicate with each other.
38. A system comprising the aerial vehicle of item 24, a designated landing area, and a mechanism for separating the replaceable battery from the aerial vehicle, wherein the mechanism is capable of autonomously reaching the majority of locations within the designated landing area and is not fixed to the length of the designated landing area, and is configured to autonomously approach the aerial vehicle after it has landed and separate the battery as part of a battery swap operation.
39. The system of item 38, wherein the mechanism for separating the replaceable battery from the aerial vehicle is attached to a robot equipped with wheels or legs, suitable for moving on the designated landing area.
40. The system of item 39, wherein the wheels are mecanum wheels or omni wheels.
41. The system of item 38, wherein the battery is detachably positioned on top of the aerial vehicle when it is in a landed state.
42. The system of item 38, wherein the battery includes a magnet or metal component that provides magnetic force to secure the battery during flight and assist in the battery separation step during the battery swap process.
43. The system of item 38, wherein the mechanism for separating the replaceable battery from the aerial vehicle comprises a battery-swapping component designed to replace the vehicle's battery, wherein the battery-swapping component comprises an arm with an electromagnet, which is vertically movable along a vertically arranged bar via a rail and carriage system.
44. Use of the aerial vehicle of item 1 for targeted pest control in an agricultural environment, for military applications or for burning weeds or leaves of unwanted vegetation.
45. The vehicle of item 1
   wherein the control unit is further configured:
      a. store data associated with each targeted pest, including location, time of day, weather conditions, and time of year, and
      b. analyze the data to identify patterns and correlations between pest prevalence and environmental factors; and
      c. optimize the vehicle's flight path based on the analyzed data to maximize the number of pests targeted.

The items of the second itemized list can be combined with one or more items of all other itemized lists in this document as well as with one or more features of the claims.

Second itemized list:
1. An autonomously operating unmanned aerial vehicle, comprising:
   a. a main body with at least one thrust producing means, and
   b. a camera for capturing images of an environment, and
   a. a laser unit for emitting a laser beam, and
   b. an optical unit operatively coupled to both the laser unit and the camera, comprising at least a dichroic mirror, wherein the dichroic mirror is configured to reflect the laser beam and to be transparent to an optical path of the camera, or vice versa,
      wherein the laser unit comprises an actuator for directing the laser beam to the dichroic mirror, or the optical unit further comprises a movable mirror at which the laser beam can be aimed for directing the laser beam to the dichroic mirror,
   c. a control unit with a processor, a memory and one or more communication units which are in data communication with the laser unit and the camera, wherein the control unit is configured to analyze the camera images to detect objects and determine their location parameters, which can be used to direct the laser beam onto targeted objects using the laser unit's actuator or the movable mirror.
2. The aerial vehicle of item 1, suitable for targeted pest control in an agricultural environment, wherein the camera is configured to capture environmental images, and the control unit is configured to analyze the images to detect pests and direct the laser beam onto the pests using the actuator or the movable mirror.
3. The aerial vehicle of item 1, suitable for military applications, wherein the camera is configured to capture images of the environment, and the control unit is configured to analyze the images to detect military targets, such as human eyes, and direct the laser beam onto the targets using the actuator or the movable mirror.
4. The aerial vehicle of item 1, suitable for burning weeds or leaves, wherein the camera is configured to capture images of the environment, and the control unit is configured to analyze the images to detect unwanted vegetation and direct the laser beam onto the vegetation using the actuator or the movable mirror.
5. The aerial vehicle of item 1, wherein the optical unit comprises a means to converge a laser beam or to focus multiple laser beams to a point in a distance when the laser unit comprises multiple laser sources for emitting multiple laser beams.
6. The aerial vehicle of item 1,
   wherein the actuator is a servo motor, and the laser unit comprises a sensor to monitor the position or positional change of the laser unit's actuator or,
   wherein the movable mirror is movable in at least one degree of freedom via an actuator, the actuator being a servo motor, and wherein the optical unit comprises a sensor to monitor the position or positional change of the movable mirror.
7. The aerial vehicle of item 6,
   wherein the degree of freedom is the pitch or the roll of the movable mirror.
8. The aerial vehicle of item 6,
   wherein the actuator is coupled to the movable mirror by a pulling cable.
9. The aerial vehicle of item 6,
   wherein the moveable mirror is coupled to a spring, rubber, or flexible structure, wherein the spring, rubber, or flexible structure is configured to apply a constant rotational force to the movable mirror, the rotational force being selected from the group consisting of pitch rotational force and roll rotational force relative to the movable mirror.
10. The aerial vehicle of item 6,
   wherein the movable mirror is actuated by a second servo motor for adjustment along at least a further degree of freedom, the further degree of freedom being selected from the group consisting of pitch and roll of the movable mirror.
11. The aerial vehicle of item 5,
   wherein the means to converge a laser beam or to focus multiple laser beams to a point in a distance is designed as follows:
the optical unit comprises a converging lens, or
the movable mirror is a concave mirror.
12. The aerial vehicle of item 11,
   wherein the converging lens has a dynamic focus length.
13. The aerial vehicle of item 1, further comprising an event camera, a stereo camera or an infrared camera in data communication with the control unit to further analyze the environment.
14. The aerial vehicle of item 1, wherein the optical unit, the laser unit, and the camera are arranged in a common housing, which is attached to the main body via a gimbal, isolating the optical unit, the laser unit, and the camera from the roll and pitch movements of the main body.
15. The aerial vehicle of item 14, wherein the gimbal is coupled to the main body via a flexible structure, such as a wire rope isolator, isolating the optical unit, the laser unit, and the camera from frequency horizontal and vertical vibrations of the main body.
16. The aerial vehicle of item 14, wherein the gimbal comprises at least two rotational axes with actuators allowing the housing to rotate about at least two axes, such that:
   the optical unit can be coarsely oriented with respect to a potential target, and fine adjustments to the alignment are made by the laser unit's actuator or the movable mirror of the optical unit, or
   the optical unit can be directed iteratively at specific subregions, scanning and targeting each subregion in succession.
17. The aerial vehicle of item 1, wherein the laser unit comprises at least one laser light source having a dominant wavelength of between 449 nm and 461 nm or between 798 nm and 818 nm.
18. The aerial vehicle of item 1, wherein the laser unit comprises multiple laser light sources for emitting multiple laser beams, wherein the laser light sources are implemented on an integrated laser chip or array.
19. The aerial vehicle of item 18, wherein a single laser driver circuit is configured to drive the multiple laser light sources.
20. The aerial vehicle of item 1, wherein the laser unit comprises a light source with a power of 5.5 W, and the light source is either a pulsed light source or a continuous one.
21. The aerial vehicle of item 1, wherein the laser unit comprises a fiber-coupled laser light source and a collimating lens.
22. The aerial vehicle of item 1, wherein the laser unit comprises a laser driver circuit utilizing at least one transistor selected from the group consisting of a Silicon Carbide (SiC) MOSFET and a Gallium Nitride (GaN) FET.
23. The aerial vehicle of item 1,
   wherein the laser unit is thermally coupled to a vapor chamber comprising a wick structure formed from a material selected from the group consisting of sintered copper powder, and a composite wick comprising at least one layer of sintered copper powder,
   wherein the vapor chamber is configured to spread the heat generated by the laser unit over a larger surface area to enhance heat dissipation.
24. The aerial vehicle of item 1, wherein the thrust-producing means comprises at least one propeller and the aerial vehicle further comprises at least one wing that generates lift when the vehicle moves forward.
25. The aerial vehicle of item 24, wherein the propeller is dynamically rearrangeable and configured to provide mainly vertical thrust or horizontal thrust.
26. The aerial vehicle of item 24, wherein the thrust-producing means comprises two propellers, wherein a first propeller is configured to provide mainly vertical thrust and a second propeller is configured to provide mainly horizontal thrust.
27. The aerial vehicle of item 1, further comprising a replaceable battery, wherein all power-consuming components on the vehicle are coupled to the battery as a power source.
28. The aerial vehicle of item 1, wherein the control unit is configured to analyze the camera images to detect objects and determine their location parameters using artificial intelligence algorithms, such as convolutional neural networks.
29. The aerial vehicle of item 28, wherein the control unit is configured to detect any human within a nominal hazard zone of the laser beam, and the aerial vehicle may comprise an infrared camera to enhance detection.
30. The aerial vehicle of item 29, wherein the nominal hazard zone is defined as a zone with a radius of 40 meters from the movable mirror or an optical unit's output, and the control unit is configured to control the laser unit or the optical unit such that it does not target any objects outside of the nominal hazard zone.
31. The aerial vehicle of item 30, wherein if a human is detected within the nominal hazard zone of the laser beam, the control unit is configured to cease neutralizing potential targets upon detection.
32. The aerial vehicle of item 1, wherein the control unit is configured to analyze the camera images for anomaly detection, using artificial intelligence algorithms to identify deviations from expected patterns.
33. The aerial vehicle of item 32, wherein the laser unit is configured to deactivate when water droplets or other reflective surfaces are detected that could unpredictably deflect the laser beam.
34. The aerial vehicle of item 1, wherein the control unit is configured to execute a location prioritization algorithm that selects locations for targeting insects based on a frequency of previous encounters with target insects at those locations.
35. The aerial vehicle of item 34,
   wherein the control unit is further configured to:
   a. store information about previous encounters with target insects at locations within an operational area; and
   b. estimate an insect emergence rate for each location based on the stored information; and
   c. select locations for targeting insects based on the estimated insect emergence rates.
36. The aerial vehicle of item 1,
   wherein the control unit is configured to:
   a. perform a cluster analysis on location parameters of a plurality of target objects to identify target-rich zones; and
   b. generate an optimized flight path for the aerial vehicle that prioritizes the target-rich zones; and
   wherein the optimized flight path is generated based on a cost function that minimizes at least one factor selected from the group consisting of: total distance traveled by the aerial vehicle, total movement of the at least one movable mirror, and a combination thereof.
37. The aerial vehicle of item 1, further comprising a plurality of independently operable beam-steering mirrors within the optical unit; and
   wherein the control unit is configured to predict trajectories of a plurality of target objects relative to the main body and to assign each target object to one of the plurality of beam-steering mirrors based on a cost function that minimizes total mirror movement.
38. The aerial vehicle of item 1, wherein the location parameters of targeted objects are stored in a database present in the memory.
39. The aerial vehicle of item 1, further comprising a cooling unit coupled with the laser unit, wherein the cooling unit employs graphene or diamond material to dissipate heat generated by the laser beam away from the laser unit.
40. The aerial vehicle of item 1, wherein the heat is transferred to a high-wind region generated by the at least one thrust-producing means.
41. The aerial vehicle of item 40, wherein the cooling unit comprises a liquid reservoir, suitable to contain water or ammonia, allowing the heat to buffer and release in periods of low laser firing, wherein the capacity of the liquid reservoir is less than 300 cm³.
42. The aerial vehicle of item 1,
   wherein the movable mirror is a first movable mirror, and the vehicle further comprises a second movable mirror, each capable of operating independently and in parallel such that the first mirror can direct the optical path of a first laser beam and the camera towards a first target, while the second mirror can direct the optical path of the first laser beam, a split of version of the first laser beam, or a second laser beam, and an additional camera towards a second target.
43. The aerial vehicle of item 1, wherein the movable mirror is positioned close to the dichroic mirror, the movable mirror having a neutral position oriented at an angle of approximately 90 degrees relative to the dichroic mirror, thereby enabling a smaller movable mirror to achieve the desired field of view for the camera.
44. The aerial vehicle of item 1,
   wherein the control unit is further configured to:
   a. perform a calibration process to determine an offset aiming point based on observed discrepancies between an intended aim point and an actual laser spot location; and
   b. utilize the offset aiming point to adjust laser aiming and account for misalignment between the dichroic mirror, the laser unit, and the camera.
45. The aerial vehicle of item 1, wherein the housing comprises multiple exit openings through which the laser beam can be directed out of the housing via the laser unit's actuator or the movable mirror.
46. The aerial vehicle of item 1, capable of targeting an object and emitting a laser beam at the targeted object while moving through a spatial environment.
47. The aerial vehicle of item 1, being configured for maintenance through the following steps:
   Generating a notification indicating that the aerial vehicle requires maintenance;
   Replacing a component of the aerial vehicle with a new component.
48. The aerial vehicle of item 1,
   wherein the optical unit comprises a means for preventing ambient light from passing through, or being reflected by, the dichroic mirror and impinging upon a sensor of the camera,
   wherein the means comprises material consisting of a dark, light-absorbing material; and a material that prevents the passing of light.
49. The aerial vehicle of item 1,
   wherein the movable mirror comprises a mirror surface having a central zone and an outer zone, the central zone being configured to reflect the at least one laser beam,
   wherein the central zone comprises a first mirror type optimized for reflecting the at least one laser beam; and
   wherein the outer zone surrounds the central zone and is configured for reflecting a field of view of the camera, the outer zone comprising a second mirror type different from said first mirror type.
50. The aerial vehicle of item 49,
   wherein the first mirror type has a higher optical quality than the second mirror type.
51. The aerial vehicle of item 49,
   wherein the second mirror type is lighter in weight than the first mirror type.
52. A drone swarm comprising a plurality of aerial vehicles according to item 1, wherein each aerial vehicle is in data communication with one another and can communicate with each other.
53. A system comprising the aerial vehicle of item 27, a designated landing area, and a mechanism for separating the replaceable battery from the aerial vehicle, wherein the mechanism is capable of autonomously reaching the majority of locations within the designated landing area and is not fixed to the length of the designated landing area, and is configured to autonomously approach the aerial vehicle after it has landed and separate the battery as part of a battery swap operation.
54. The system of item 53, wherein the mechanism for separating the replaceable battery from the aerial vehicle is attached to a robot equipped with wheels or legs, suitable for moving on the designated landing area.
55. The system of item 54, wherein the wheels are mecanum wheels or omni wheels.
56. The system of item 53, wherein the battery is detachably positioned on top of the aerial vehicle when it is in a landed state.
57. The system of item 53, wherein the battery includes a magnet or metal component that provides magnetic force to secure the battery during flight and assist in the battery separation step during the battery swap process.
58. The system of item 53, wherein the mechanism for separating the replaceable battery from the aerial vehicle comprises a battery-swapping component designed to replace the vehicle's battery, wherein the battery-swapping component comprises an arm with an electromagnet, which is vertically movable along a vertically arranged bar via a rail and carriage system.
59. Use of the aerial vehicle of item 1 for targeted pest control in an agricultural environment, for military applications or for burning weeds or leaves of unwanted vegetation.
60. The vehicle of item 1
   wherein the control unit is further configured:
      a. store data associated with each targeted pest, including location, time of day, weather conditions, and time of year, and
      b. analyze the data to identify patterns and correlations between pest prevalence and environmental factors; and
      c. optimize the vehicle's flight path based on the analyzed data to maximize the number of pests targeted.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. An autonomously operating unmanned aerial vehicle, comprising:
a. a main body with at least one thrust producing means, and
a. a camera for capturing images of an environment, and
b. a laser unit for emitting at least one laser beam, and
c. an optical unit operatively coupled to both the laser unit and the camera, comprising at least one movable mirror and a dichroic mirror, wherein the dichroic mirror is configured to reflect the laser beam and to be transparent to an optical path of the camera, or vice versa, so that the optical path of the camera is aligned with a path of the laser beam and both the optical path of the laser beam and the optical path of the camera are directed at the movable mirror,
d. a control unit with a processor, a memory and one or more communication units which are in data communication with the laser unit, the camera and the optical unit, wherein the control unit is configured to analyze the camera images to detect objects and determine their location parameters, which can be used to direct the laser beam onto targeted objects using the moveable mirror.

2. The aerial vehicle of claim 1, suitable for targeted pest control in an agricultural environment, wherein the camera is configured to capture environmental images of the agricultural environment, and the control unit is configured to analyze the camera images to detect pests and determine their location parameters, which can be used to direct the laser beam onto targeted pests using the moveable mirror.

3. The aerial vehicle of claim 1, suitable for military applications, wherein the camera is configured to capture images of the environment, and the control unit is configured to analyze the camera images to detect military targets, such as human eyes, and determine their location parameters, which can be used to direct the laser beam onto the military targets using the moveable mirror.

4. The aerial vehicle of claim 1, suitable for burning weeds or leaves, wherein the camera is configured to capture images of the environment, and the control unit is configured to analyze the camera images to detect unwanted vegetation and determine their location parameters, which can be used to direct the laser beam onto the weeds or leaves using the moveable mirror.

5. The aerial vehicle of claim 1,
wherein the optical unit comprises a means to converge a laser beam or to focus multiple laser beams to a point in a distance when the laser unit comprises multiple laser sources for emitting multiple laser beams.

6. The aerial vehicle of claim 1,
wherein the movable mirror is movable in at least one degree of freedom via an actuator, the actuator being a servo motor, and wherein the optical unit comprises a sensor to monitor the position or positional change of the movable mirror.

7. The aerial vehicle of claim 6,
wherein the degree of freedom is the pitch or the roll of the movable mirror.

8. The aerial vehicle of claim 6,
wherein the actuator is coupled to the movable mirror by a pulling cable.

9. The aerial vehicle of claim 6,
wherein the moveable mirror is coupled to a spring, rubber, or flexible structure, wherein the spring, rubber, or flexible structure is configured to apply a constant rotational force to the movable mirror, the rotational force being selected from the group consisting of pitch rotational force and roll rotational force relative to the movable mirror.

10. The aerial vehicle of claim 6,
wherein the movable mirror is actuated by a second servo motor for adjustment along at least a further degree of freedom, the further degree of freedom being selected from the group consisting of pitch and roll of the movable mirror.

11. The aerial vehicle of claim 1,
wherein the optical unit comprises a galvo steering system with the movable mirror being part of it.

12. The aerial vehicle of claim 5,
wherein the means to converge a laser beam or to focus multiple laser beams to a point in a distance is designed as follows:
the optical unit comprises a converging lens, or
the movable mirror is a concave mirror.

13. The aerial vehicle of claim 12,
wherein converging lens is a dynamic focus length.

14. The aerial vehicle of claim 1,
further comprising an event camera, a stereo camera, or an infrared camera in data communication with the control unit to further analyze the environment.

15. The aerial vehicle of claim 1,
wherein the optical unit, the laser unit and the camera are arranged in a common housing which is attached to the main body via a gimbal, isolating the optical unit, the laser unit and the camera from the roll and pitch movements of the main body.

16. The aerial vehicle of claim 15,
wherein the gimbal is coupled to the main body via a flexible structure, such as a wire rope isolator, isolating the optical unit, the laser unit and the camera from frequency horizontal and vertical vibrations of the main body.

17. The aerial vehicle of claim 15,
wherein the gimbal comprises at least two rotational axes with actuators allowing the housing to rotate about at least two axes, so that
(i) the optical unit can be coarsely oriented with respect to a potential target, and the movable mirror of the optical unit is capable of performing fine adjustments to the alignment of the camera's optical path or the laser beam, or
(ii) the optical unit can be iteratively directed at specific subregions of an area under the vehicle, scanning and cleaning each subregion under the vehicle in succession.

18. The aerial vehicle of claim 1,
wherein the laser unit comprises at least one laser light source having a dominant wavelength of between 449 nm and 461 nm or of between 798 nm and 818 nm.

19. The aerial vehicle of claim 1,
wherein the laser unit comprises multiple laser light sources for emitting multiple laser beams, wherein the laser light sources are implemented on an integrated laser chip or array.

20. The aerial vehicle of claim 19,
wherein a single laser driver circuit is configured to drive the multiple laser light sources.

21. The aerial vehicle of claim 1,
wherein the laser unit comprises a light source with a power of 5.5 W, and the light source is either a pulsed light source or a continuous one.

22. The aerial vehicle of claim 1,
wherein the laser unit comprises a fiber coupled laser light source, and a collimating lens.

23. The aerial vehicle of claim 1,
wherein the laser unit comprises a laser driver circuit utilizing at least one transistor selected from the group consisting of a Silicon Carbide (SiC) MOSFET and a Gallium Nitride (GaN) FET.

24. The aerial vehicle of claim 1,
wherein the laser unit is thermally coupled to a vapor chamber comprising a wick structure formed from a material selected from the group consisting of sintered copper powder, and a composite wick comprising at least one layer of sintered copper powder,
wherein the vapor chamber is configured to spread the heat generated by the laser unit over a larger surface area to enhance heat dissipation.

25. The aerial vehicle of claim 1,
wherein the thrust producing means comprises at least one propeller and the aerial vehicle further comprises at least one wing that generates lift when the vehicle moves forward.

26. The aerial vehicle of claim 25,
wherein the propeller is dynamically rearrangeable and configured to provide mainly vertical thrust or horizontal thrust.

27. The aerial vehicle of claim 25,
wherein the thrust producing means comprises two propellers, wherein a first propeller is configured to provide mainly vertical thrust and a second propeller is configured to provide mainly horizontal thrust.

28. The aerial vehicle of claim 1,
further comprising a replaceable battery, wherein all power consuming components on the vehicle are coupled to the battery as a power source.

29. The aerial vehicle of claim 1,
wherein the control unit is configured to analyze the camera images to detect objects and determine their location parameters using artificial intelligence algorithms, such as convolutional neural networks.

30. The aerial vehicle of claim 29,
wherein the control unit is configured to detect any human in a nominal hazard zone of the laser beam, wherein the aerial vehicle may comprise an infrared camera to enhance detection.

31. The aerial vehicle of claim 30,
wherein the nominal hazard zone is defined as a zone with a radius of 40 meters from the movable mirror, and wherein the control unit is configured to control the laser unit or the optical unit such that it does not target any objects outside of the nominal hazard zone.

32. The aerial vehicle of claim 30,
wherein if a human is detected within the nominal hazard zone of the laser beam, the control unit is configured to cease neutralizing potential targets upon detection.

33. The aerial vehicle of claim 1,
wherein the control unit is configured to analyze the camera images to anomaly detection, using artificial intelligence algorithms to identify deviations from expected patterns.

34. The aerial vehicle of claim 23,
wherein the laser unit is configured to deactivate when water droplets or other reflective surfaces are detected that could unpredictably deflect the laser beam.

35. The aerial vehicle of claim 1,
wherein the control unit is configured to execute a location prioritization algorithm that selects locations for targeting insects based on a frequency of previous encounters with target insects at those locations.

36. The aerial vehicle of claim 35,
wherein the control unit is further configured to:
a. store information about previous encounters with target insects at locations within an operational area; and
b. estimate an insect emergence rate for each location based on the stored information; and
c. select locations for targeting insects based on the estimated insect emergence rates.

37. The aerial vehicle of claim 1,
wherein the control unit is configured to:
a. perform a cluster analysis on location parameters of a plurality of target objects to identify target-rich zones; and
b. generate an optimized flight path for the aerial vehicle that prioritizes the target-rich zones; and
wherein the optimized flight path is generated based on a cost function that minimizes at least one factor selected from the group consisting of: total distance traveled by the aerial vehicle, total movement of the at least one movable mirror, and a combination thereof.

38. The aerial vehicle of claim 1, further comprising a plurality of independently operable beam-steering mirrors within the optical unit; and
wherein the control unit is configured to predict trajectories of a plurality of target objects relative to the main body and to assign each target object to one of the plurality of beam-steering mirrors based on a cost function that minimizes total mirror movement.

39. The aerial vehicle of claim 1,
wherein the location parameters of targeted objects are stored in a database present in the memory.

40. The aerial vehicle of claim 1,
further comprising a cooling unit coupled with the laser unit, wherein the cooling unit employs graphene or diamond material, allowing to dissipate heat generated by the laser beam away from the laser unit.

41. The aerial vehicle of claim 40,
wherein the heat is transferred to a high-wind region generated by the at least one thrust producing means.

42. The aerial vehicle of claim 41,
wherein the cooling unit comprises a liquid reservoir, suitable to contain water or ammonia, allowing the heat to buffer and to release in periods of low laser firing, wherein capacity of the liquid reservoir is less than 300 cm³.

43. The aerial vehicle of claim 1,
wherein the movable mirror is a first movable mirror, and the vehicle further comprises a second movable mirror, each capable of operating independently and in parallel such that the first mirror can direct the optical path of a first laser beam and the camera towards a first target, while the second mirror can direct the optical path of the first laser beam, a split of version of the first laser beam, or a second laser beam, and an additional camera towards a second target.

44. The aerial vehicle of claim 1,
wherein the movable mirror is positioned close to the dichroic mirror, the movable mirror having a neutral position oriented at an angle of approximately 90 degrees relative to the dichroic mirror, thereby enabling a smaller movable mirror to achieve the desired field of view for the camera.

45. The aerial vehicle of claim 1,
wherein the control unit is further configured to:
a. perform a calibration process to determine an offset aiming point based on observed discrepancies between an intended aim point and an actual laser spot location; and
b. utilize the offset aiming point to adjust laser aiming and account for misalignment between the dichroic mirror, the laser unit, and the camera.

46. The aerial vehicle of claim 1,
wherein the housing comprises multiple exit openings through which the laser beam can be directed out of the housing via the movable mirror.

47. The aerial vehicle of claim 1, capable of targeting an object and emitting a laser beam at the targeted object while moving through a spatial environment.

48. The aerial vehicle of claim 1, being configured for maintenance through the following steps:
Generating a notification indicating that the aerial vehicle requires maintenance;
Replacing a component of the aerial vehicle with a new component.

49. The aerial vehicle of claim 1,
wherein the optical unit comprises a means for preventing ambient light from passing through, or being reflected by, the dichroic mirror and impinging upon a sensor of the camera,
wherein the means comprises material consisting of a dark, light-absorbing material; and a material that prevents the passing of light.

50. The aerial vehicle of claim 1,
wherein the movable mirror comprises a mirror surface having a central zone and an outer zone, the central zone being configured to reflect the at least one laser beam,
wherein the central zone comprises a first mirror type optimized for reflecting the at least one laser beam; and
wherein the outer zone surrounds the central zone and is configured for reflecting a field of view of the camera, the outer zone comprising a second mirror type different from said first mirror type.

51. The aerial vehicle of claim 50,
wherein the first mirror type has a higher optical quality than the second mirror type.

52. The aerial vehicle of claim 50,
wherein the second mirror type is lighter in weight than the first mirror type

53. A drone swarm comprising a plurality of aerial vehicles according to claim 1, wherein each aerial vehicle is in data communication with one another and can communicate with each other.

54. A system comprising the aerial vehicle of claim 28, a designated landing area and a mechanism for separating the replaceable battery from the aerial vehicle, wherein the mechanism is capable of autonomously reaching the majority of locations within the designated landing area and is not fixed to the length of the designated landing area, and is configured to autonomously approach the aerial vehicle after it has landed on the designated landing area, and separate the battery from the aerial vehicle as part of a battery swap operation.

55. The system of claim 54,
wherein the mechanism for separating the replaceable battery from the aerial vehicle is attached to a robot equipped with wheels or legs, suitable for moving on the designated landing area.

56. The system of claim 55,
wherein the wheels are mecanum wheels or omni wheels.

57. The system of claim 54,
wherein the battery is detachably positioned on top of the aerial vehicle when it is in a landed state

58. The system of claim 54,
wherein the battery includes a magnet or metal component that provides magnetic force to secure the battery during flight and assist in the battery separation step during the battery swap process.

59. The system of claim 54,
wherein the mechanism for separating the replaceable battery from the aerial vehicle comprises a battery-swapping component designed to replace the vehicle's battery, wherein the battery-swapping component comprises an arm with an electromagnet, which is vertically movable along a vertically arranged bar via a rail and carriage system.

60. An autonomously operating unmanned aerial vehicle, comprising:
a. a main body with at least one thrust producing means, and
b. a camera for capturing images of an environment, and
d. a laser unit for emitting a laser beam, and
e. an optical unit operatively coupled to both the laser unit and the camera, comprising at least a dichroic mirror, wherein the dichroic mirror is configured to reflect the laser beam and to be transparent to an optical path of the camera, or vice versa,
wherein the laser unit comprises an actuator for directing the laser beam to the dichroic mirror, or the optical unit further comprises a movable mirror at which the laser beam can be aimed for directing the laser beam to the dichroic mirror,
c. a control unit with a processor, a memory and one or more communication units which are in data communication with the laser unit and the camera, wherein the control unit is configured to analyze the camera images to detect objects and determine their location parameters, which can be used to direct the laser beam onto targeted objects using the laser unit's actuator or the movable mirror.

61. An autonomously operating unmanned aerial vehicle, comprising:
a. a main body with at least one thrust producing means, and
d. a camera for capturing images of an environment, and
e. a laser unit for emitting a laser beam, and
b. a control unit with a processor, a memory and one or more communication units which are in data communication with the laser unit and the camera, wherein the control unit is configured to analyze the camera images to detect objects and determine their location parameters, which can be used to direct the laser beam onto targeted objects.

62. The aerial vehicle of claim 61, wherein the laser unit comprises an actuator for directing the laser beam, or the aerial vehicle further comprises an optical unit with a movable mirror at which the laser beam can be aimed for directing the laser beam.

63. The aerial vehicle of claim 61, further comprising a rotary motor assembly configured to steer the laser beam,
wherein the rotary motor assembly comprises:
rotary motor coupled to a mirror, the rotary motor being configured to rotate the mirror in response to an applied signal;
an integrated driver circuit three-dimensionally stacked with at least one component of the rotary motor, wherein the integrated driver circuit comprises at least one of:
through-silicon vias (TSVs) for vertical electrical connections;
a silicon interposer for interconnecting stacked dies; and
wafer-level packaging (WLP); and
wherein at least one component of the galvo motor assembly is fabricated from a lightweight material selected from the group consisting of titanium and aluminium.

64. The aerial vehicle of claim 63, wherein the rotary motor comprises a piezoelectric motor.

65. Use of the aerial vehicle of claim 1 for targeted pest control in an agricultural environment, for military applications or for burning weeds or leaves of unwanted vegetation.

66. Use of the aerial vehicle of claim 60 for targeted pest control in an agricultural environment, for military applications or for burning weeds or leaves of unwanted vegetation.

67. Use of the aerial vehicle of claim 61 for targeted pest control in an agricultural environment, for military applications or for burning weeds or leaves of unwanted vegetation.

68. The vehicle of claim 1
wherein the control unit is further configured:
a. store data associated with each targeted pest, including location, time of day, weather conditions, and time of year, and
b. analyze the data to identify patterns and correlations between pest prevalence and environmental factors; and
c. optimize the vehicle's flight path based on the analyzed data to maximize the number of pests targeted.

69. The vehicle of claim 60
wherein the control unit is further configured:
a. store data associated with each targeted pest, including location, time of day, weather conditions, and time of year, and
b. analyze the data to identify patterns and correlations between pest prevalence and environmental factors; and
c. optimize the vehicle's flight path based on the analyzed data to maximize the number of pests targeted.

70. The vehicle of claim 61
wherein the control unit is further configured:
a. store data associated with each targeted pest, including location, time of day, weather conditions, and time of year, and
b. analyze the data to identify patterns and correlations between pest prevalence and environmental factors; and
c. optimize the vehicle's flight path based on the analyzed data to maximize the number of pests targeted.
